(19) United States
(12) Patent Application Publication
(10) Pub. No.: US 2002/0124182 A1
(43) Pub. Date: Sep. 5, 2002

(54) Method and system for targeted content delivery, presentation, management and reporting in a communications nertwork

(76) Inventors: Stephen R. Bacso, Kitchener (CA); Rene J. Juneau, Thornhill (CA); Sanjeev Shankar, Waterloo (CA); Bruce D. Scanlan, Waterloo (CA)

Correspondence Address: SHUMAKER & SIEFFERT, P. A., 8425 SEASONS PARKWAY, SUITE 105, ST. PAUL, MN, 55125, US

(21) Appl. No.: 09/991,566

(22) Filed: Nov. 20, 2001

(30) Foreign Application Priority Data
Nov. 20, 2000 (CA) 2,326,368

(51) Int. Cl. G06F 11/30

(52) U.S. Cl. 713/200

(57) ABSTRACT

A method is described for the targeting of content presentation to individual users in a communications network including management and reporting, comprising the steps of receiving from content providers, potential content for presentation to users and presenting to a user content selected from said potential content based on information known about said user. Facilities are also provided to receive from users requests for content and other actions related to receipt of said content such as ‘pause’ requests, and to record and report the fact that said content has been presented to said user.

### BACKGROUND OF THE INVENTION

1. Field of the Invention

The technology domain for the invention is information technology management and networking technology that can be applied with analog and digital communication networks to provide targeted content to subscriber or groups of subscribers viewing content on those networks. Networks can include cable, satellite, terrestrial broadcast, cellular, packet-switched or other forms of telephony, data communications, and television and radio broadcast and distribution.

2. Background

A variety of specifications exist for transmission of digital television, radio, telephony and related data. In the Internet world, new formats and protocols for video compression and transmission are constantly appearing. Within these environments, proprietary and open specifications have evolved for transmitting data and applications which can operate independently of or in conjunction with the default audio, video and data content. Security mechanisms have evolved with these systems to manage authorization and purchase functions, using smart card chips, custom chips and software, and a variety of encryption schemes.

Within the digital television world, advertising technology has remained relatively unchanged since television's widespread introduction in the 1950s, with no targeting capability or response capability. Some technology has been proposed for targeting content in the area of advertising, including but not limited to U.S. Pat. No. 5,319,455 (System for distributing customized commercials to television viewers), U.S. Pat. No. 5,155,591 (Method and Apparatus for providing demographically targeted television commercials), U.S. Pat. No. 6,018,768 (Enhanced Video Programming System and Method for incorporating and displaying retrieved Internet information segments), and U.S. Pat. No. 4,602,279 (Method for providing targeted profile interactive CATV displays). Additional patents valuing and grouping individuals for the advertisement targeting process have been issued or filed, including U.S. Pat. No. 5,724,521 (Method and apparatus for providing electronic advertisements to end users in a consumer best-fit pricing manner), and applicant's co-pending United States Patent application entitled ‘Method and System for Targeted Advertising’.

Digital television systems are capable of simultaneously transmitting hundreds or thousands of services, each consisting of one or more streams of audio, video, data, and interactive applications, all known as ‘content’.

While broadcast television is still by far the most popular entertainment and information medium, the Internet has been viewed by some as a superior technology because of its capabilities for dynamically targeting content based on user input and information, and for identifying the user and reporting back on the user's access and response to the content.

Systems have been designed and proposed for adding targeting and response capabilities to television advertising. These systems appear in large part to have been developed piecemeal, without reference to the evolving realities of the digital television. Many of these systems have met some, but not all, of the requirements listed below:

Adaptable and usable by legacy and new digital receivers

Able to transmit simultaneously content to multiple incompatible distribution and receiver systems on the same or multiple networks

Able to consolidate delivery records and feedback from receivers from multiple incompatible networks and receivers.

New receivers able to connect to and receive content not only from new network types, but also various combinations of existing and new network types and protocols.

Able to evolve with new receiver capabilities, while maintaining compatibility with existing receivers.

Able to provide reporting and feedback through relatively low-bandwidth and expensive telephone connections securely and at a reasonable cost

Take advantage of open standards and potential standards for interactive applications

Dynamically adapt the targeting and selection mechanisms to meet the changing needs of content providers including advertisers

Provide security and confidentiality of all customer data and actions

Permit the targeting of not just the advertisement, but any form of content from data to applications to television programs

Ability to work in a passive television viewing environment, without requiring input or interaction from the user

Ability to work in receivers where short or long-term persistent storage of profile information is not available

Ability to control the allocation of resources like disk space and memory storage on the receiver

Ability to provide supported functions at a reasonable cost.

The business of broadcasting continues to evolve. Major operators each provide multiple services, and must sell advertising space across these services.

Digital receivers are also rapidly evolving, and are able to offer capabilities such as dual-tuners, disk drives for program recording and playback, and high-speed Internet access. These capabilities open the door for the invention of new opportunities to provide customized or targeted content including advertising, as well as new forms of content

New platforms for information dissemination are appearing. Telephones, whether stationary, connected through the Internet, or cellular, are evolving into sophisticated devices with capabilities for receiving and sending text messages, faxing, connecting to the Internet, and playing games. Content can be delivered to these devices in the form of new information, games or advertisements. Security, as with digital television systems, is sophisticated and can also include smart cards.

It is apparent that there is a growing need to take greater advantage of the digital revolution to allow better targeting of program or content to the viewer or user. Any system which is capable of providing benefits to the content providers as well as the user will enjoy considerable market success. Users and viewers likewise will be better served by some degree of integration of content, catering more specifically to their needs than is practical with traditional broadcasting, even with specialist channels having narrow focus. Users are faced with major problems in determining just what their viewing or listening choices are in the face of 200 or more broadcast channels. By the time the user has surfed the network, the program is finished . . .

To make targeted advertising and content delivery a reality for large-scale deployment, the technology must:

make innovative use of legacy receiver facilities and technology,

work with official and de-facto standards for transmission and interactivity

have the ability to take advantage of new features

maintain compatibility or interoperability with the legacy systems.

### SUMMARY OF THE INVENTION

What is needed is a ubiquitous system capable of providing the content providers with a series of mechanisms to allow them to deliver a targeted or customized content stream created from a number of independent sources and for the users the ability to control the content customized for them sufficiently to avoid the frustration of either information overload (through there being too much choice) or lack of control (through the targeting being too specific and limiting).

The invention is a method and system for the targeting of content presentation to individual users in a communications network including management and reporting, and comprises the steps of receiving from content providers, potential content for presentation to users, and presenting to a user content selected from said potential content based on information known about said user

In the description below, the examples given often turn to the paradigm of programs interleaved with advertising, but it should be recognized that any system requiring customized interleaving of content from multiple diverse sources lends itself to being improved by application of the methods and systems of the present invention, as described herein or in the associated applications.

It will be recognized by those skilled in the art that the use of digital media for storage or transmission of content or data is not a requirement, but rather the systems and methods may be more conveniently described in terms of such media. The use of analog facilities that may be conveniently adapted is therefore assumed to be included in the description.

The present invention relates to methods and systems for transmission, management and presentation of content to viewers and users of a digital medium such as digital television, radio or Internet, and to methods and systems for collecting data on their viewing records and habits.

In order to meet these objectives and overcome the shortcomings of previous systems, the invention makes use of several interacting subsystems, each described in some detail below, several of them being the subject of co-pending applications as specified.

In addition, the invention is designed to permit a degree of flexibility in implementation, so that some functional aspects of each subsystem are optional, and some interactions between subsystems are also optional.

In traditional program or content providing systems, programs are sent to the user in a predetermined sequence, usually in real time, and with no opportunity to adjust the sequence of the content, although in some cases, (e.g. by using a Personal Video Recorders) timing can be adjusted under the control of the user. To provide the infrastructure necessary for the invention, in addition to the content (e.g. programs or advertisements), extra information in the form of metadata is sent to the digital receiver, either synchronously or asynchronously. This metadata consists of a description of the content (e.g. programs, advertisements) its availability and protocol format if needed, information on opportunities for presenting the content, and information and processes for matching content to opportunities).

Management methods in digital receivers monitor the transmitted stream and provide storage and storage management mechanisms for alternate versions of content, acquire content from alternate sources, control access to the storage and data, and securely acquire, store and retrieve characteristic information used in the selection process.

Presentation methods in the receiver display the content based on protocol, format and opportunity information from the transmission stream, opportunities created by function invocation by the user, physical and temporal content availability, and processes for matching the content to the opportunities. The matching process may have complex requirements including multi-service broadcaster requirements, multi-message content sequencing, and user preferences including ratings and permissions such as those used in implementations of V-Chip technology, which is used to broadcast ratings with the programming and allow receivers to block viewing of programs with ratings deemed inappropriate. Combinations of all of the above methods provide precise timing and event synchronization capability for the presentation of the content.

The reporting methods provide content viewing information to a data reporting facility

### BRIEF DESCRIPTION OF THE DRAWINGS

The present invention will be described with reference to the accompanying drawings wherein:

FIG. A1 is a schematic of a network of one embodiment of the present invention

FIG. A2 is a schematic of a receiver in one embodiment of the present invention

FIG. A3 is a schematic of the functions required in a receiver for content targeting

FIG. A4 is a table representing data for describing targeted content

FIG. A5 is a table representing data for content targeting opportunities.

FIG. 1 is an overview of a system for targeted content presentation in communications networks according to an embodiment of the present invention;

FIG. 2 shows an automated reporting system in accordance with the present invention;

FIG. 3 shows a system for presenting target content system in accordance with the present invention;

FIG. 4 shows a receiver system in accordance with the present invention;

FIG. 5 shows a method for presenting targeted content in accordance with the present invention;

FIG. 6 shows a method for presenting targeted content in accordance with the present invention;

FIG. 7 shows a method for presenting targeted content in accordance with the present invention;

FIG. 8 shows a method for presenting targeted content system in accordance with the present invention;

FIG. 9 shows a method for presenting targeted content system in accordance with the present invention;

FIG. 10 shows a method for presenting targeted content system in accordance with the present invention; and

FIG. 11 shows a method for presenting targeted content system in accordance with the present invention.

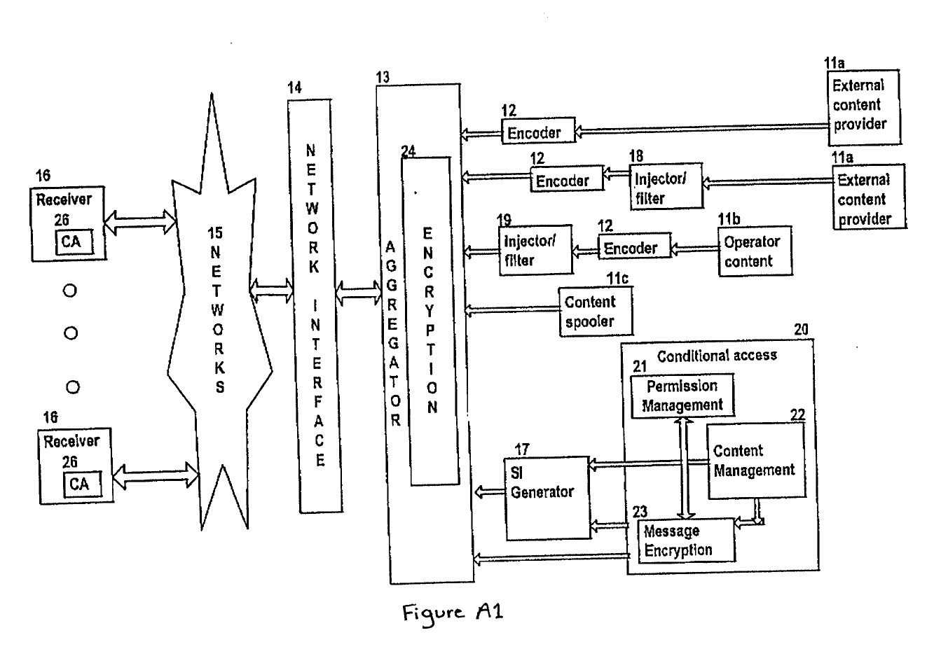

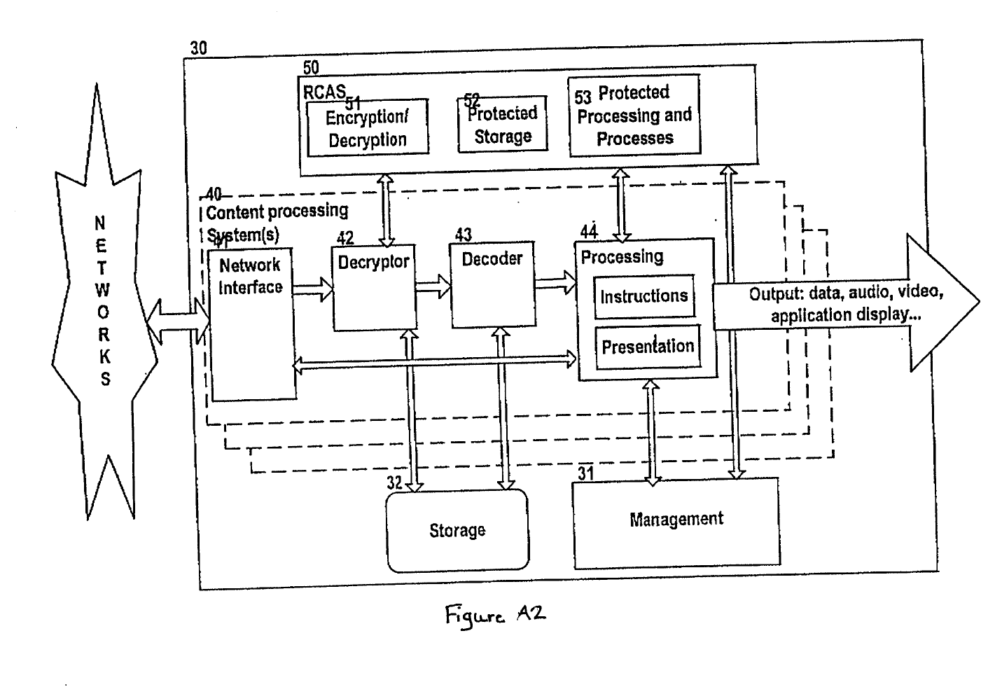

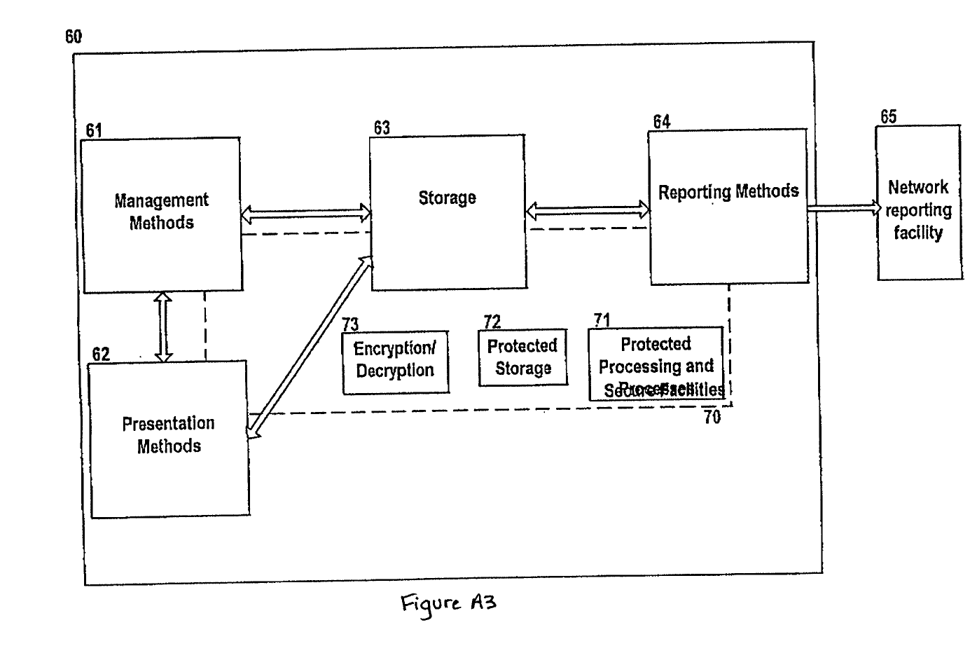

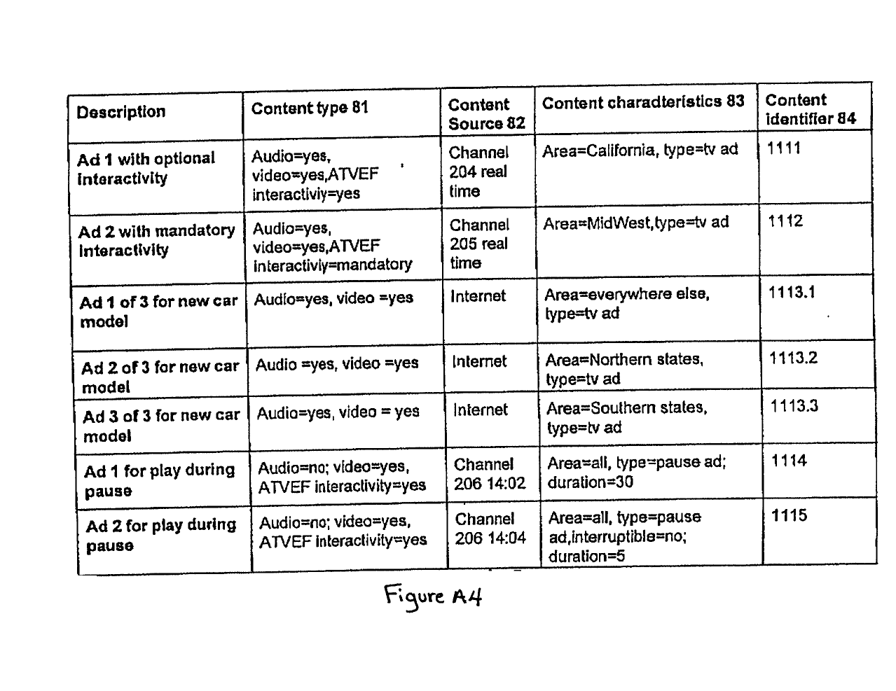

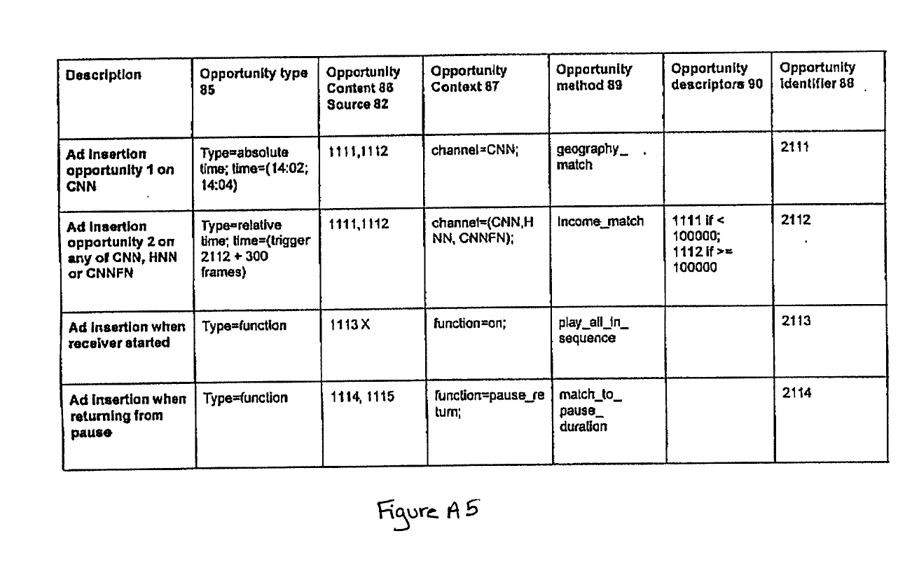

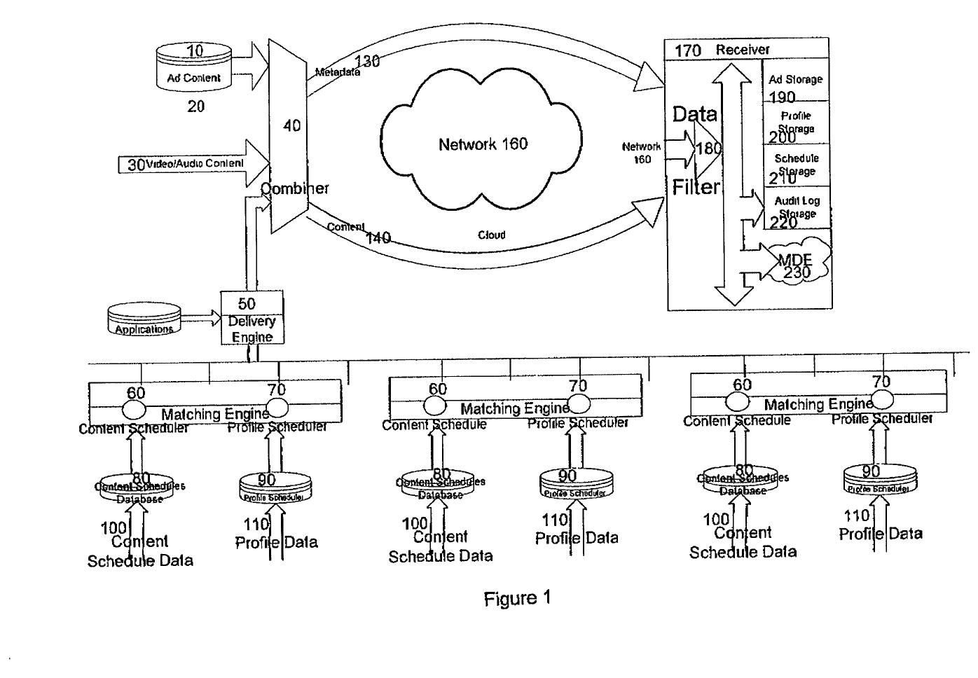

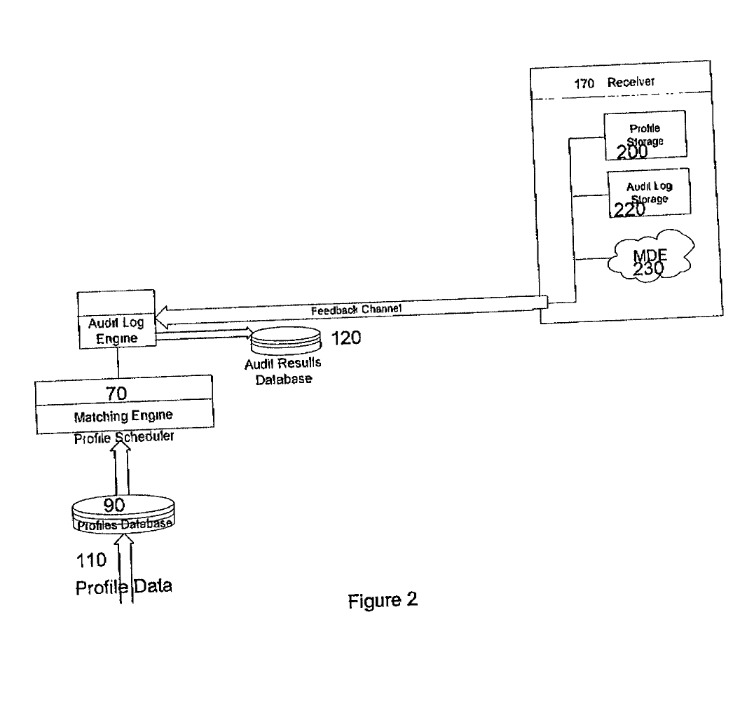

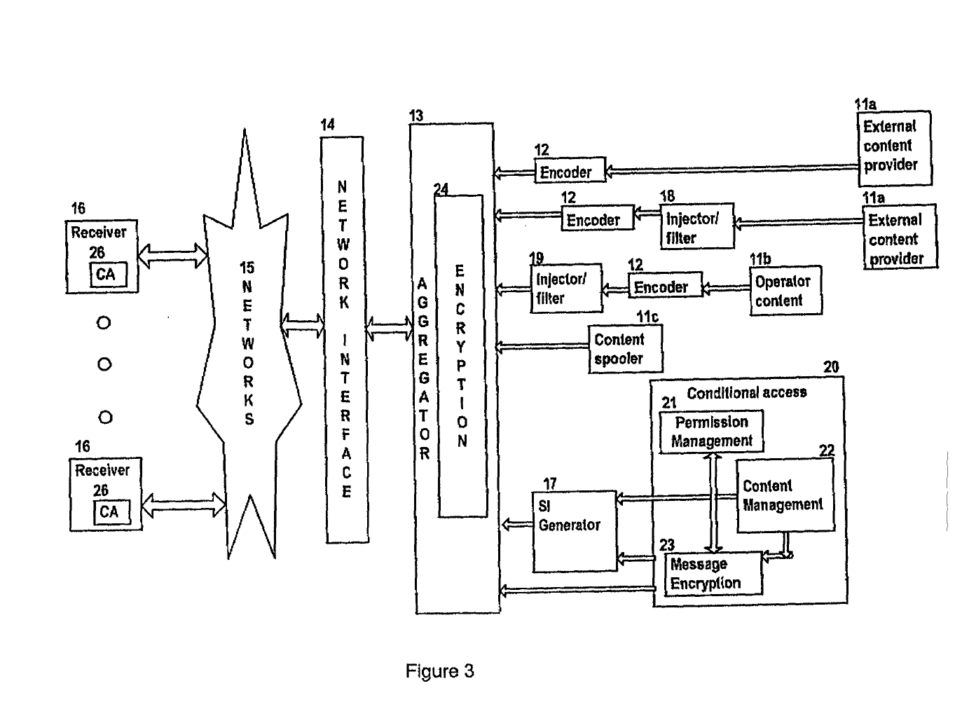

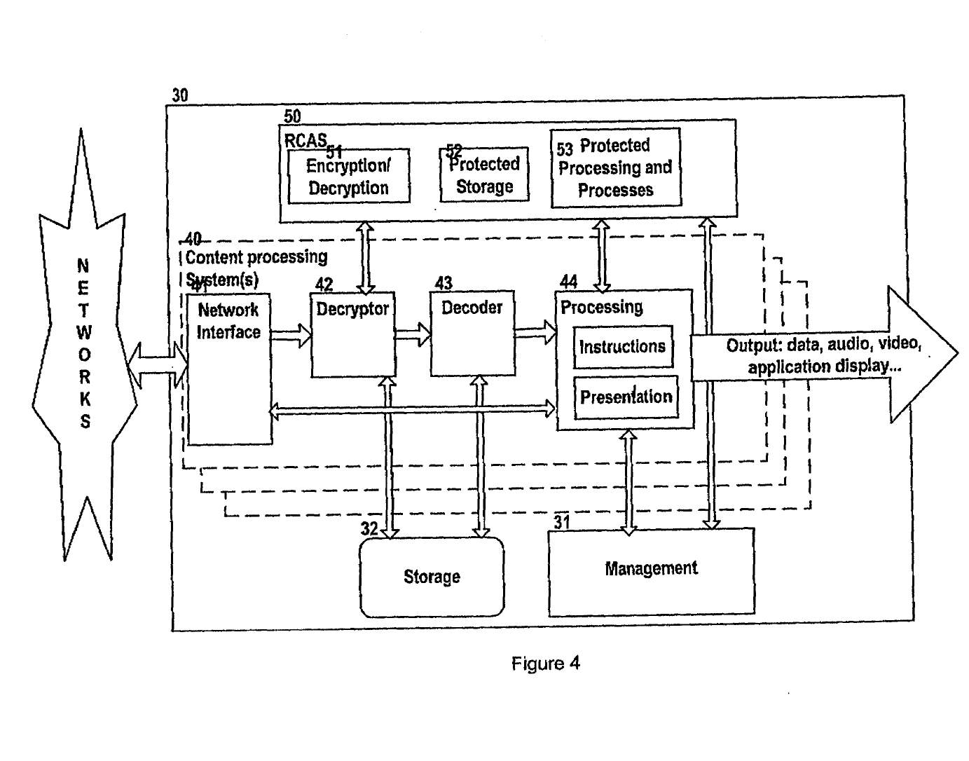

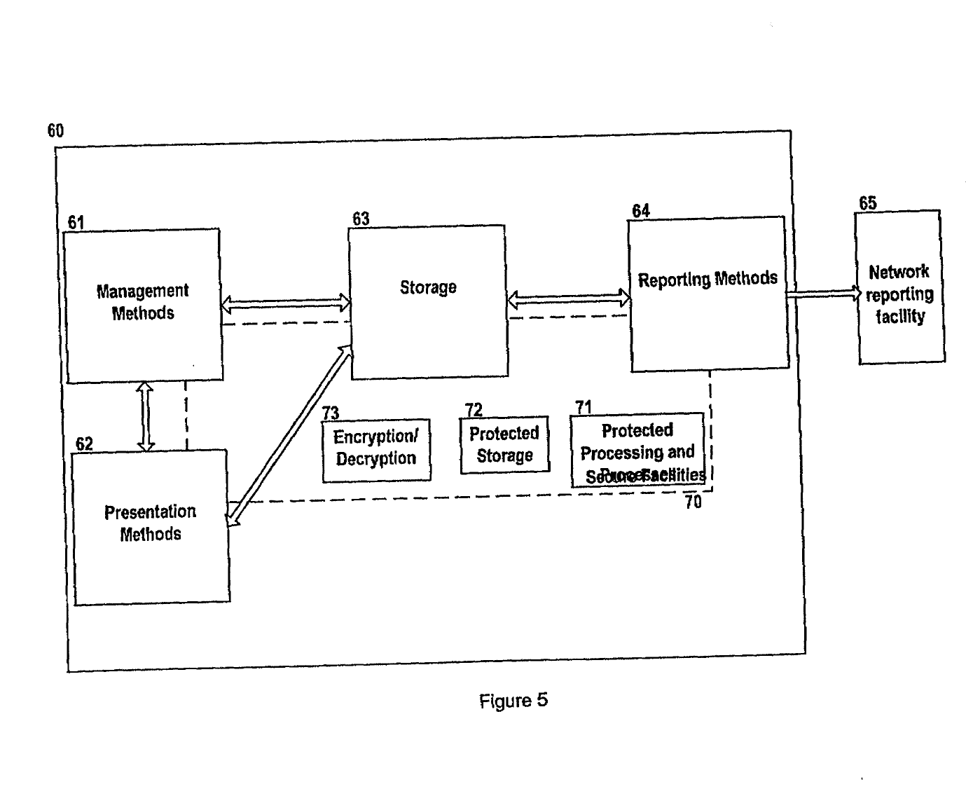

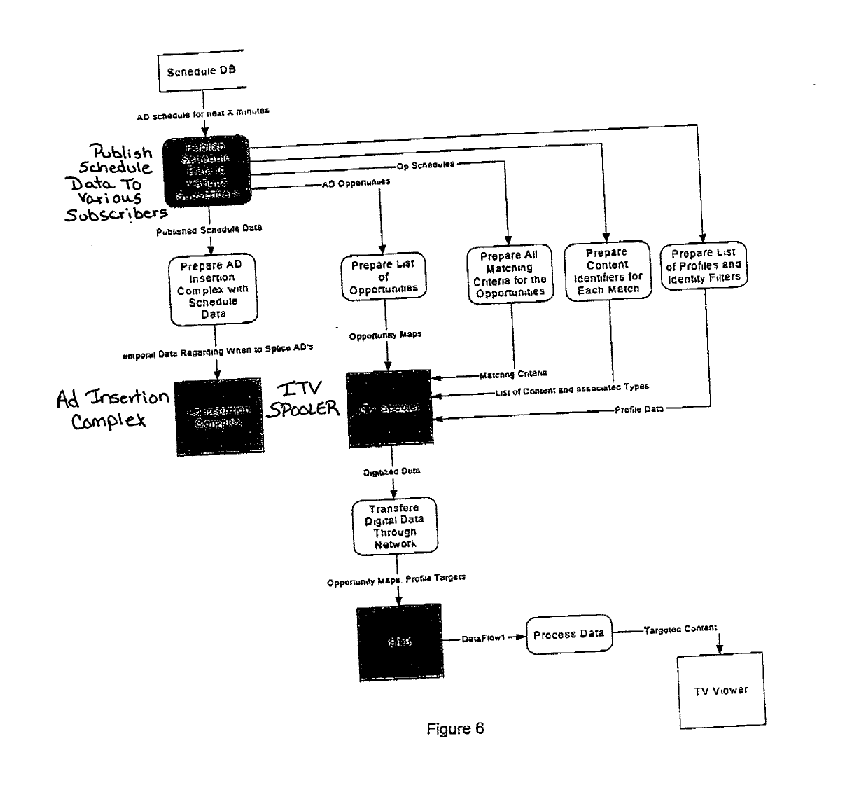

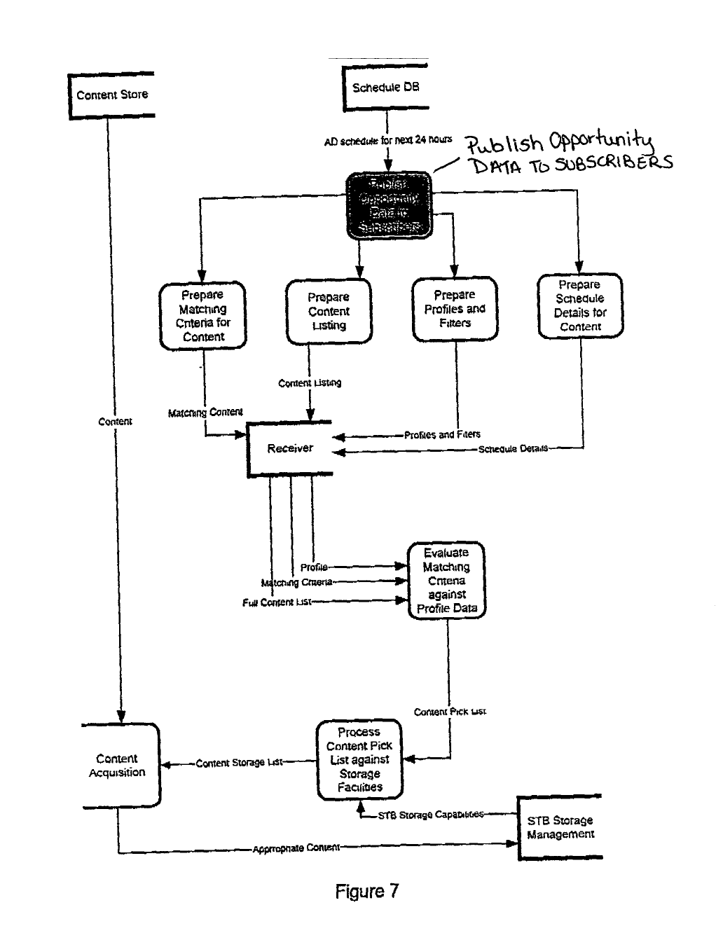

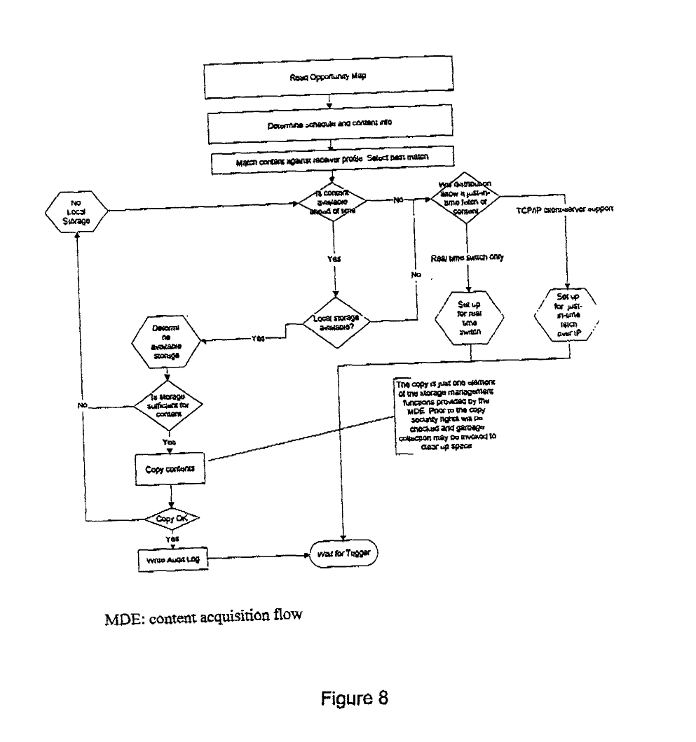

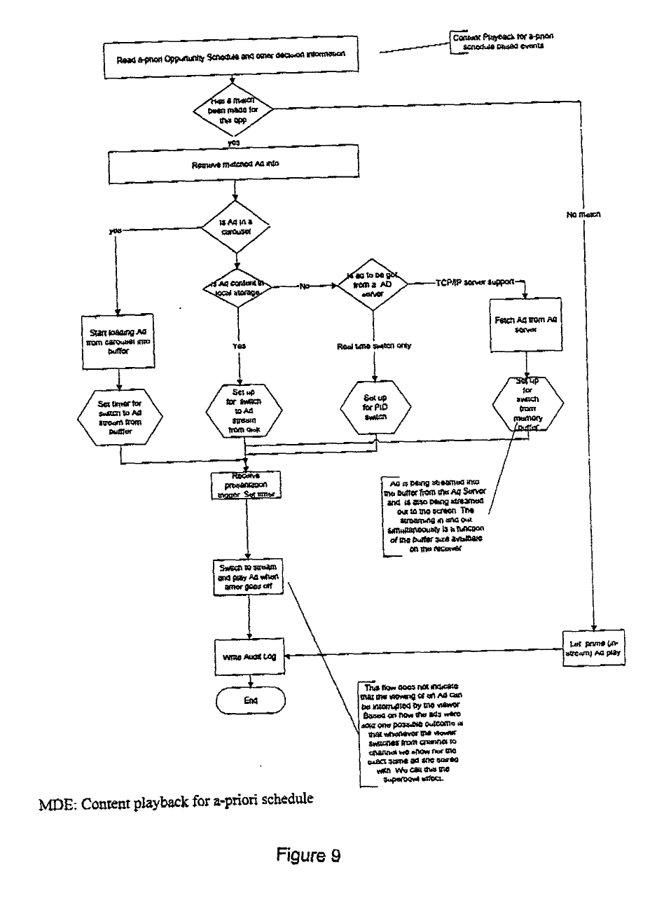

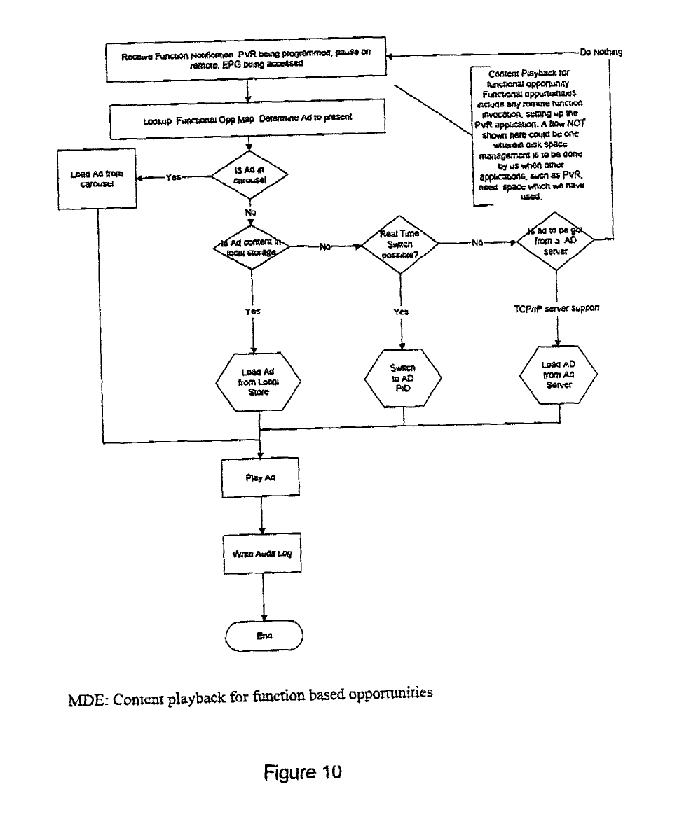

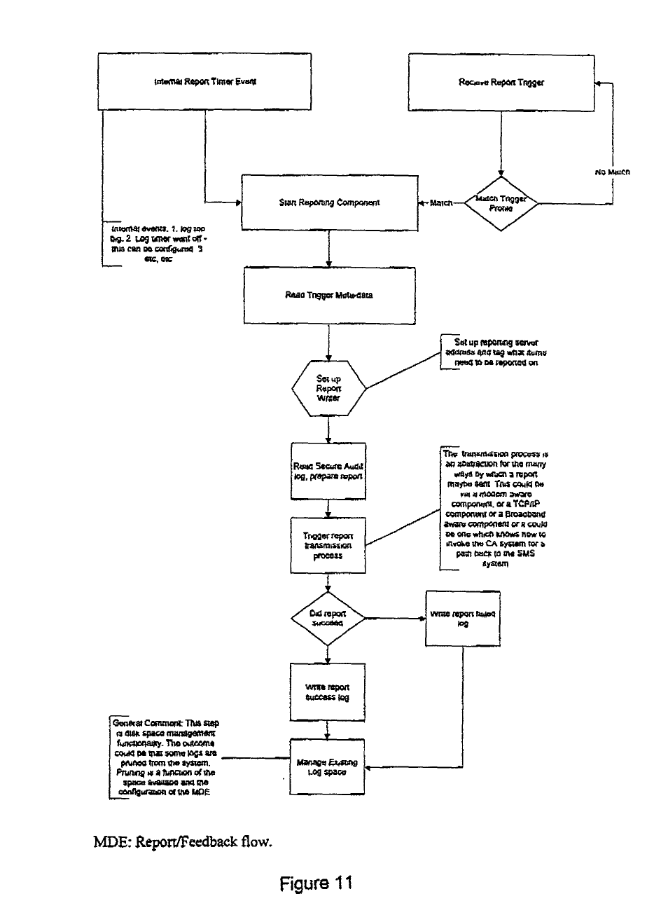

### DETAILED DESCRIPTION

Network Environment

FIG. A1 shows the functional components of a network system 10 for the distribution of content. These components are applicable to a variety of content distribution systems, including cable and satellite television. The components could reside on a single physical system, or they may reside on separate systems linked by one or more communication networks. Multiple instances of each component may also be required depending on the number of content sources used and other parameters. The network system 10 includes one or more content sources, which might be from external sources 11a as well as from internal sources 11b produced by the network system operator. Content may also be available in pre-encoded form from an internal content spooler or server 11c. Content from the spooler/server and other sources may be transmitted in real-time, or slower or faster than real-time for purposes of caching content for deferred viewing.

Typically, content flows into encoders 12 which process the content prior to distribution. From the encoders, the processed content flows into a content aggregator 13 for delivery, through a network interface 14 to a network 15 for delivery to a plurality of receivers 16. The network may provide multiple facilities for communication between the receiver and the control networks, and may consist of separate distinct communication facilities.

Along with the content from content providers 11a, 11b, 11c, various forms of data are transmitted to aid the user in the use of a multi-channel, multi-service system. This type of information, which can include the electronic program guide and related tables for access, frequency and other information for receiving and describing the signal, are known as service information (SI) tables. SI tables are produced and transmitted by the SI generator 17, and can also include various forms of control information from external sources to control access for content like subscription services and pay-per-view movies, and other forms of information on the content that may be of use to the receiver 16.

Security and authorization are provided by the conditional access system 20 (CAS). The CAS determines which content the user is allowed to access. The CAS comprises permission management 21 for control of authorizations on a per user or receiver basis, content management 22 for controlling access to content, and a message encryption 23 facility to secure the communication authorization and other messages for transmission. The CAS may also make use of a content encryption system 24 for protection of the content during transmission. Each receiver connected to the network system must also contain a component of the CAS 26 for communication with the operator's CAS and for local secure storage of permission and content access information.

In a typical embodiment, the content is an audio and video signal from a broadcaster, and the encoder 12 is an MPEG-2 compressor which converts the signal from analog to digital format and then compresses and synchronises the components into MPEG-2 data streams. The aggregator 13 is an MPEG-2 multiplexor which creates a multiplexed transport stream delivered to the network interface 14, which in this case is a modulator appropriate to a cable television network. The network 15 is the system of amplifiers, transmitters, re-transmitters, copper cable, fiber optic systems, switches and routers used for distribution of the signal. The receivers 16 are connected to the cable network, and communicate back with the operator using Internet, DAVIC (Digital Audio Video Council, Geneva, Switzerland) and/or other command protocols supported by the network 15.

Receiver Environment

FIG. A2 depicts the functions and facilities required for a user to receive the content from a network described in FIG. A1. A receiver's functions and facilities may be contained within a set-top device on the viewing premises or distributed throughout a network. The receiver contains one or more content processing systems 40 (CPS). Each CPS requires a network interface 41 for communication to and from the operators' network(s), a decryptor 42 for deciphering any secured information, a decoder 43 for converting from the network format to the viewing or usage format, and a processing element 44 for handling any instructions, graphics processing, multi-media combining or other formatting required before presentation to the user. A management system 31 is required for co-coordinating the operation of the various functions. Content storage 32 is used to record information pertinent to the usage of the system, and for content storage and playback.

The receiver component 26 of the CAS 20 consists of one or more receiver content authorization systems 50 (RCAS), which control access to content and facilities independently or in conjunction making use of synchronous or asynchronous communication with the CAS 20. Before allowing content to pass through the decryption 42, decoding 43 and other steps required for viewing or usage, the management system 31 may communicate with the RCAS 50 to determine if access is allowed or to obtain access through purchasing or other mechanisms, as is typical in impulse pay-per-view purchases. The RCAS process 50 may include protected storage 52, processing and processes 53, access to which may be restricted through interfaces and protocols. Separate encryption and decryption facilities 51 may be included for secure management of communications to and from the RCAS.

Other examples of RCAS 50 include digital television conditional access systems implemented with individual encryption of each content stream, encryption key generation systems, command and authorization streams which are also encrypted, and capture, decryption and storage of CA permissions within the receiver or separate facilities such as a smart card within the receiver. Systems for managing commercial transaction may provide similar functions to the RCAS in the receiver, operating in separate facilities or integrated with the CA RCAS system. As another example, the receiver can perform an authorization check whenever access to content is requested, as implemented on switched packet networks using TCP/IP, ATM and other protocols, including the Internet and the various authorization schemes supported by servers, and digital subscriber line (DSL) distribution networks, including the ADSL, VDSL and other implementations. Other security systems and authorization mechanisms will occur to those of skill in the art.

Physical embodiments of receivers include any or all of the following operating alone or in combination: digital set-top cable and satellite receivers; integrated components within digital televisions; personal computers with appropriate network connections, cellular telephones and personal digital assistants (PDAs) connected through wireless networks and occasional computer network hook-ups, and gaming consoles. A receiver's functions may be contained within local equipment or distributed throughout a network. For example, when using xDSL equipment or the Internet, a channel change request to a set-top receiver sends a signal to control equipment on the operator's network, which changes the program stream being transmitted to the receiver.

Some embodiments include more than one content processing systems 40, for example to allow simultaneous processing of multiple streams for picture-in-picture viewing, watching one program while recording another to storage, or surfing the Internet while watching a television program.

In some embodiments, content storage 32 may be provided or augmented by storage within a network provided by the operator of the network. The storage may consist of a portion of storage with a maximum capacity assigned by the operator. The maximum capacity can be based on an actual physical quantity of storage, or a virtual quantity of storage, where multiple users can share the same instance of content in storage, in which case the maximum storage for a user is based on the content requested to be stored by the user. Similarly, RCAS facilities 50 and other functions of the receiver may be provided by appropriate processing and storage elements within the network provided by the operator of the network.

In other embodiments, content storage 32 may be provided or augmented by sharing resources among one or more receivers and equipment accessible to receivers on a network within the user's premises. Individual set-tops may share disk space among them; personal computers on the network may receive alternate versions of content, which can be selected by the targeting and matching processes; and storage on the personal computers can be used to record content. With proper design, authorization, logging and other functions may be performed on one device for other connected devices, thereby providing a form of . . . Similarly, RCAS facilities 50 and other functions required to receive content may be provided by suitable processing and storage elements within the user's local network.

Physical embodiments of the processing 44 and management 31 components can receive, process and present to the user applications that integrate text, data, graphics and audio/video content, interact with the user for input, and provide feedback across a network connection. Implementations may take the form of an embedded software system with the required functions, an operating system with integrated functions, or applications and libraries accessible to an operating system or embedded system.

Content Targeting Overview

The targeting of content is broadly defined as the exploitation of opportunities to present users with one of a number of alternative versions of content. Opportunities can be based on segments of content that can be substituted for alternate segments; on dynamic alteration of the content; and on presentation based on the invocation of functions by the user.

When the opportunity for content targeting is presented, appropriate content is selected to exploit the opportunity. In this way, the content the user receives can be specifically tailored to the user, without the tailoring and selection process necessarily being apparent to the user. While user input is not required, data and preferences entered or selected by the user can be incorporated in the process.

When the content is presented and viewed, the receiver can record the identity of the content being viewed and report the results to a reporting facility. Based on the results, the content providers can further tailor the content and parameters to match content to the desired users.

In some embodiments, the opportunity exists to allow a portion of the content to be replaced by content from some other source. For example, a baseball video game or program may include a “background billboard”, which is used to display an advertisement, in still or moving video form. The advertisement is selected based on parameters and functions selected by the programmer. The information required to permit this is made available from metadata describing the game, graphical application or video program, as well by attributes of the content itself.

Referring now to FIG. A3 which illustrates the functional components required within a receiver for content targeting. These components together are referred to as the targeting methods 60 and are required for matching the content to the opportunities. The management methods 61 process the content descriptors and assess which content to retrieve for possible presentation. The presentation methods 62 process the opportunity descriptors and the opportunity events, match the content to the opportunity, present the content, and store the result of the viewing in storage 63. Both the management methods 61 and the presentation methods 62 can access the storage 63 to retrieve data to assist in the decision making process. The reporting methods 64 retrieve and process viewing information, and send the information to a network reporting facility 65. Data used in the decision making process is placed in and retrieved from storage 63 by the management methods 61. The management methods 61 receive or retrieve the data from the network, or from the presentation methods 62 through which the user interfaces to retrieve, add, delete or modify the data.

The secure facilities 70 can provide portions of the management methods 61, presentation methods 62, storage 63 and reporting methods 64. Security facilities provide controlled access to the data, and can also provide encryption, decryption, processing and communication facilities for the methods 61, 62 and 64.

The Receiver Content Authorization System RCAS 50 may be dedicated to the content targeting processes 60; dedicated to the a digital television conditional access system which is extended to provide storage and processing functions for content targeting purposes; dedicated to an e-commerce subsystem which contains its own smart card; or have some dedicated components and some shared components between digital television authorization systems, e-commerce systems the targeting methods.

Content Selection Using Content Descriptors

FIG. A4 shows a list of content and related characteristics. The content type 81 allows the receiver to determine if it is capable of showing the content. For example, alternate versions of a single ad may be available as different audio/video clips or as a graphical application with interactivity options. A receiver without interactivity would ignore the application version. The type may be represented as a value or as a data structure representing complex options within the piece of content. In one embodiment, the data structure is represented as a data structure showing both the properties and the requirement for presenting those properties. In the table, clip “Ad 1 with optional interactivity” indicates that audio, video and interactivity are present in the clip, but interactivity is not required. A receiver not equipped for interactivity could still show only the audio and video. Clip “Ad 2 with mandatory interactivity” has audio and video that is directly tied to the interactive component, and could not be used by this receiver.

The content source 82 allows the receiver, based on its capabilities, to determine if the content is accessible. The content characteristics 83 describe the contents targeting attributes. The number and types of characteristics are dynamic, and can grow or change over time. Content characteristics can include but are not limited to:

Temporal sensitivity—including maximum showings per time interval; minimum intervals between showings; time window in which the content can be used.

Repeatability—maximum number of showings

Characteristics for matching the content to the opportunity

Conditional access system control information

Opportunity type

Access rights to identify the source of the content.

Other characteristics are known to those of skill in the art.

The content identifier 84 is a unique code used for storage, and retrieval and for reporting of the content's usage. The identifier can also include a sequence component to indicate that the content in question is one of many in a series, and its sequence within the series.

Access rights within the characteristics are used to ensure that the content, and, in particular, its use of resources like storage, network and processing facilities, is appropriate to the receiver and the operator's network(s). Use of access rights is particularly important for operators, as fees and technical considerations may be required for the operator to allow the application to be transmitted. As an example, commands may be contained within the interactive stream, but not permitted for all applications.

Access to storage can be controlled through privileges in secure facilities 70. The authorization codes required are encrypted and included as a parameter in the characteristics. Encryption at the network operator site can be performed by the CAS 20 or in a separate system, including content injectors 18 or 19 located at the network operator's site, content supplier sites, or other service provider sites, while decryption at the receiver and authorization for access to facilities is handled within the secure facilities 70. Message encryptors 23 are commonly implemented in conditional access systems, and implementation details will occur to those of skill in the art.

Opportunity Descriptors

FIG. A5 shows a list of content display opportunities.

The opportunity type 85 describes how the content display opportunity will be initiated. Mechanisms include an absolute schedule, with a time at which content is to be presented; a relative schedule, with a time relative to another event or trigger; a function invocation, where the use of a feature on the receiver can trigger the display of content.

The opportunity content list 86 shows the content that can be selected for display. This field is related to the content identifier 84 of FIG. A4.

The opportunity context 87 determines when and where the content is to be displayed. Examples of context include one or more of the following, and are not limited to:

A specific stream—the content is only to be displayed on a given service

A group of streams—the content is to be displayed on any one of a number of services

The invocation of a function on the receiver, such as PAUSE.

A time window for function invocation—the content is to be displayed if the user hits the PAUSE button between 18:00 and 19:00

The opportunity identifier 88 uniquely identifies the opportunity for reporting purposes.

Function invocations are based on user input through receiver controls, including and not limited to switches on the receiver, remote controls, mice, keyboards and other input devices; commands and trigger signals sent with the video; commands sent across a wired or wireless network through other devices. Opportunities are tailored and customized for a receiver's capabilities, and may be based on the invocation of a series of one or more functions, and the timing and context of the function invocation.

Determining the result of a condition test involves the execution of a complex function in which a variety of conditions can occur based on data from the network and input from the user.

Examples of function based opportunities include the triggering of content display when an electronic program guide (EPG) function is selected, or when playback, application or game control functions including but not limited to ON, OFF fast forward FF, rewind REW, and PAUSE are used on appropriately equipped receivers. The algorithm for assessing the opportunity not only matches the content to the opportunity, but also determines if the opportunity will be exploited in this invocation by assessing the timing of prior function invocations.

Algorithms may be designed to use multiple facilities to ensure a high probability of showing a sequence of content within a give timeframe, with a high degree of independence of the content being watched. For example, a content provider like Time Warner with multiple services (CNN, HNN, TNT, CNNFN, etc.) may request that a series of advertisements be presented in sequence between 20:00 and 22:00, taking advantage of opportunities occurring on all their services from function invocation. For each advertisement in the series, multiple versions may be available, and the matching algorithms for the opportunities will make the appropriate selection.

The opportunity method 89 indicates which method should be used to match the opportunity to the content. The method may be a reference to a function available in the receiver; a function that is acquired from the network; a function that is included in the opportunity descriptor; or a combination of all of the preceding, with the appropriate method or combination of methods being selected based on the capabilities of the receiver and connected network.

To give but one example, the opportunity with description “Ad insertion when user returns from pause” in FIG. A5 uses method “match_to_pause_duration”, and the selection is based on the user returning to viewing after selection the pause function. The method is designed to minimize the annoyance of the user, and is based on the duration of the pause and the time since pause was last used. The results of the algorithm are that:

The ad will not be shown if there was a return from pause within some definable interval

If the pause was used within some definable period, then content will be selected that is less than some definable length

If the pause has not been used in some other definable period, then content of duration less than some definable amount will be played.

The opportunity descriptor 90 is a set of data that matches user group characteristics with a probability for each user group to be a user during the opportunity. Processes and methods for this type of match can be found in the applicant's co-pending application entitled “Method and System for targeted Advertising”. As is the case for content descriptors, the opportunity descriptors may include encrypted components using the same encryption and decryption schemes.

In some embodiments, secure processing facilities 71 including storage 72 are provided where the opportunity method 89, in whole or in part, may be executed. The processing may include parameters and algorithms already in the secure storage 72, or the parameters and algorithms may be passed to the secure processing facilities 71 in encrypted or unencrypted format. In this way, the retrieval of data by unauthorized services, persons or functions outside of the secure facilities is limited, and only the results of the match are returned to the requesting method.

Content Descriptor and Opportunity Descriptor Transmission

The content descriptors are transmitted to the receiver in any of the content transmission mechanisms outlined in, but not limited to, the descriptions of FIG. A1.

The content and opportunity descriptors are provided as data in a joint stream or in separate streams to a process on the receiver. The format is appropriate to the network, and examples include DVB TCP/IP streams on a satellite network and an IP data-casting stream on the Internet. Multiple instances of descriptor and content streams may occur, each associated with a content service like a television channel; or the content streams may be in streams which are independent of the content service.

In another embodiment the content and opportunity descriptors are included in the vertical blanking interval or other portion of the video signal as is done today for closed captioning, teletext and analog TV ATVEF transport A, or MPEG mechanisms for carrying closed captioning fields and related data within picture headers and control information.

Content and opportunity descriptors are not necessarily transmitted separately. In a simplified implementation, the content and opportunity descriptors may all be included within a function call, with the function representing the method of the opportunity descriptor.

Matching of Opportunities to Content

Among other methods, the characteristics of the content and opportunities can be matched based on methods and systems described in the applicant's co-pending United States Patent application entitled “Method and System for Targeted Advertising”. The characteristics for matching can include, but are not limited to, any or all of:

Demographic characteristics

Psychographic characteristics

Temporal characteristics

Geographic characteristics

Behavioral characteristics.

The selection of the content alternatives, the selection and attribution of characteristics to opportunities and content, the transmission mechanisms selected for the content and opportunities, and the methods used for matching the content and opportunities can be based on yield management methods, an example of which is optimal dynamic pricing.

The potential for dynamic pricing is maximized in this invention by the ability to update content and/or content characteristics and to transmit matching methods as characteristics up to the time of the exploitation of the opportunity.

The targeting and pricing can be applied to receivers taking advantage of user characteristics known to the operator and usable within the methods described herein, with results being derived from a sample of receivers, or by an independent sampling of users with similar characteristics. This precludes the necessity of having all receivers constantly or periodically report the activities of their users.

Delivery of Alternate Versions of Content

As described in prior art, multiple versions of a television channel can be transmitted synchronously, and, using a variety of mechanisms based on user input, the receiver can switch between the different channels to create a custom version of the program. This invention provides four different mechanisms for synchronous content transmission.

The first method involves a synchronization of multiple streams of unrelated content. The streams are related only for targeting purposes, and not by their content. Each stream has different content, e.g. advertisements; however, the timing of the content is synchronized across the streams. At the start of each portion of content, the receiver can switch to a different channel for the duration of the inserted content if the content on the other channel is determined to be more appropriate, e.g. if it is a version of an ad that has not been seen by the user.

The second method involves adding additional streams for alternate versions of the content. As in the first method, the streams are linked to a plurality of content streams which are related only for management purposes, and not by content. By scheduling advertisements at different times on the content streams, the alternate content streams can be shared among the principal content streams.

The third method makes capacity available by manipulating content streams to eliminate the redundancy caused by simultaneous substitution on networks where regulations require that when the same program is broadcast simultaneously from a local provider and a foreign provider, that the local provider's program replace the foreign provider's program on the foreign channel broadcast. Current network implementations sometimes result in the local program being transmitted redundantly on both channels

The fourth method delivers content over facilities which might not otherwise be fully utilized, such as those provided for the use of part-time services.

In switched environments such as but not limited to DSL networks and video speed Internet, with sufficient pre-roll time, content can be queued and selected at the appropriate time. Within xDSL and Internet environments, a single stream of content can be multicast to a plurality of receivers.

For asynchronous content transmission, any of the network mechanisms discussed (broadcast or point-to point) can be used. Content on these networks can be transmitted in real-time, or slower or faster than real-time at fixed or variable speeds at alternate times, using transmission formats different from the normal video transmission. For example, a satellite stream for alternate content being transmitted asynchronously may consist of broadcast TCP/IP file transfers within DVB streams, instead of the MPEG-2 packetization normally expected of video streams.

The asynchronous acquisition of content is based on the capabilities of the receiver, and can be done in parallel with viewing activities, and/or when there is no usage of the receiver.

Management Methods

The receiver management methods are processes for accessing, retrieving, storing and deleting content and data.

Embodiments of the receiver 30 will vary in their capabilities, and in particular in the number of instances of the content processing system 40. Embodiments of the receiver can acquire content descriptors and content based on the transmission methods described earlier, and will vary based on the implementation of the receiver. Examples of content descriptor acquisition include the following:

As part of a completely independent content acquisition stream. This method requires that the receiver either be equipped to handle a separate stream other than the viewed stream, or that the content from such a stream be acquired when the receiver is not used for viewing. In a cable or satellite receiver, this requires component(s) to provide separate frequency tuning, demodulation and decrypting functions, or access to another source or technology like the Internet.

As part of a co-located stream that can be processed while content is being viewed.

As part of a dynamic stream that includes both content descriptors and content opportunities.

As part of a response to a user request for content, in which descriptions of alternate versions or segments of the content are included

By sending a message directly to the receiver

For acquiring content, the management method uses a sequence of steps which includes any or all of, but is not limited to, the following steps:

a) monitoring of the content descriptor transmission stream

b) matching the content descriptors with the receiver capabilities

c) verifying that permission is available to access the content

d) matching of the content descriptors to the user information

e) selecting the descriptors with the strongest content match

f) if storage is available to the receiver

Determining if the content is already in storage

Determining if the content can be acquired in a timely manner

Verifying access rights to storage

Verifying availability of storage

Making storage available by determining if content can be deleted

Making storage available by comparing matches of the new content with existing content in storage, and replacing content with weaker matches

g) acquiring content from the designated source and placing it in storage

The management method also receives characteristic information on the users from the operator. This data may be based on the subscription information provided to the operator by the user, or information the operator has acquired from other sources.

This user data may be received in encrypted or unencrypted format. In one embodiment, to prevent unauthorized access, the data may be kept in encrypted format, and may be kept within the facilities of an RCAS 50, although other secure facilities may also be used.

Presentation Methods

The presentation methods process information on content display opportunities, match opportunity to the available content and the user information, present the content at the appropriate time, and report on the results.

The presentation methods use a sequence of steps which includes any or all of, but are not limited to, the following steps:

For scheduled content opportunities:

a) monitoring the programming stream for opportunities and content descriptors

b) passing content descriptors to the management methods for assessment

c) matching the opportunity to the available content and the user characteristics

d) presenting the content to the user

e) updating log

f) secure logging of the viewing result

g) secure reporting of the viewing result

For functional content opportunities:

a) monitoring of programming and content streams for opportunities and content descriptors

b) passing content descriptors to the management methods for assessment

c) pre-matching the opportunities to the available content and user characteristics

d) at function invocation, determining appropriateness of a content insertion

e) if appropriate, presenting the content to the user

f) updating pre-matched opportunities for next function invocation

g) secure logging of the viewing result

Another example of the use of secure facilities for storage of data and execution of methods is the maintaining of confidentiality of the viewing records, even when use of those records is required for assessing the appropriate content to show when a content viewing opportunity arises. The following sequence illustrates the selection of the ad from a sequence of ads based on previous views:

a) if all ads in sequence have not been viewed yet, report back sequence number

b) report the viewing to the reporting facility

c) if all ads have been viewed:

If repeats allowed, reset sequence number and report back the first number in the sequence

If repeats not allowed, report back a different advertisement.

Once the presentation of an alternative piece of content has started, the display of the content is interrupted by the use of functions like channel changes. A characteristic of the content or the opportunity can deem the content to be uninterruptible, in which case the content will play to completion before other functions are allowed to proceed. Another characteristic is conditional uninterruptability, in which case the content can continue to play if certain conditions are met. In the case of multiple content channels with synchronized ad start times described earlier, a change to one of the channels in which the opportunity is being co-coordinated would continue to play.

The presentation methods can also handle and manage user input to control the triggering of functional opportunities. The logging of results can include all inputs from the user. These inputs can be processed within the receiver or at a network site to as part of the analysis of viewing habits and, based on the frequency, selection of inputs, and the resulting content selections, can be used to identify the user with a reasonable probability.

The detail level of the logging of the interactions and selections can be based on user selections and permissions performed at the receiver, or based on agreements between the network operator and the user, with the operator transmitting permissions to the receiver to set the logging level based on the agreements. These agreements can include some form of payment, discount or other credit for the user.

The reporting methods can process the data to produce derived data for subsequent targeting opportunities. The processing and the storage of the resulting data can be performed in whole or in part within the facilities of the RCAS 50.

Following processing and reporting of data, the reporting methods manage the space used by the data, and can delete data based on temporal factors, completion of processing, reporting and other considerations.

Timing Mechanisms for Content Switching

When an opportunity for targeting contents results in the switch from one content stream to another—whether the content is from another stream, storage or another source—the system must switch as seamlessly as possible from the original to the alternate stream.

Access to an alternate stream may not be instantaneous. Preparation required prior to switching streams can include:

Locating and retrieving content from disk

Access latency related to the storage devices and network performance. Examples include disk access and Internet router and transmission latency

For concurrent streams, tuning to an alternate frequency and starting the conditional access decryption process.

Another problem is that the start time is not absolute. A television program does not always start exactly on time—and even if it does, the start time is relative to the content provider's own clock. Even if all content providers operate from the same master clock, factors like satellite transmission delay, MPEG packet jitter and re-clocking and other effects will result in start time variations for different programs when received by the operator.

An advance pre-roll trigger can be used to within the opportunity to descriptor to advise the receiver that the content substitution must start in an amount of time relative to a reference clock, at an absolute time relative to a reference clock, or in an amount of time relative to a data trigger. The exact method will depend on the capabilities of the receiver.

When switching from one content stream to and from an alternative piece of content, perceptible delays are to be avoided.

When seamless or near-seamless transitions are not possible, the alternate content can be modified to accommodate delays in tuning to and returning from the alternate content selection. These modifications can include designing the content so that the start and end portions are less relevant and not significant to the message if missed; a temporal compression of the alternate content so that the start and end are blank or irrelevant for the amount of time it takes, and the message is shortened from its original length through accelerated playback or the removal of selected frames to fit within the shortened display time.

Reporting Methods

Reporting methods are used to report both viewing records and user behaviour to a reporting facility. The viewing behavior can be used to determine which user was actually watching the targeted content selection, or any other content available on the system.

A reporting level, selectable by the user or by command transmission from the operator, is used to determine the level of detail the reporting methods will transmit to the operator for data collection and analysis. By agreeing to or selecting a more detailed reporting level, a user may receive payment, discount or other consideration from the operator or a statistics-gathering firm like ACNielsen (Stamford, Conn.).

The reporting system also provides facilities to help determine which user in a multi-user household was watching the content, without requiring any active input from the user. For the most precise user identification, biometric mechanisms can be included in the receiver or the remote control. In one embodiment, the remote control includes a finger or thumb print reader. The remote cannot be used unless the appropriate finger is in the reader portion of the device to identify the user. Simpler and less accurate methods like the selection of a user profile on the receiver can be used.

Any inputs and viewing records must be stored and transmitted securely, and will use any of the RCAS 50 features available. The reporting process will be based on the capabilities of the receiver, and may be done in real-time or on a deferred basis. The deferred basis is particularly important when the network for reporting is the telephone network, and the operator is paying toll charges for the telephone call. An aggregation and occasional reporting of the stored data will reduce in substantial cost savings.

The detail level of the reporting of the interactions and selections can be based on user selections and permissions performed at the receiver, or based on agreements between the network operator and the user, with the operator transmitting permissions to the receiver to set the logging level based on the agreements.

Heterogeneous Environment Support

A broadcaster or network operator typically must support multiple receiver and network types for the distribution of their content.

This system is able to support multiple network and receiver hardware and software combinations. Each of these possible combinations are referred to as a delivery model.

The delivery models can be supported as elementary targeting mechanisms, where advertisers and broadcaster can choose to deliver content based on the capabilities of groups of receivers and their respective networks.

At the matching engine and delivery engine levels, the system retains and uses formation about each delivery model and the various components of the distribution network. Information can include but is not limited to:

Logic execution capabilities and specifications

Network latency for specific services and equipment that affect presentation timing

Receiver types and features, including memory, local and network storage, network connections and capabilities

Data available to receivers

Bandwidth for delivery to receivers

Number of receivers within each delivery model

User characteristics for each receiver

The information is used for purposes such as:

Consolidating feedback from network and receiver components into a common format for reporting to networks, advertisers and other parties

Generating the algorithms for transmission to the receivers

Management of and scheduling of transmission (timing and bandwidth)

The heterogeneous network support allows for the physical separation and independent management of components. Matching engine functions can be located at broadcasters or other content providers, and can communicate with multiple delivery engine functions at other broadcasters and network operators. Network operator matching engines and delivery engines can in turn be receiving targeting information from multiple broadcasters and content distributors.

Additional Content Matching and Targeting Mechanisms

In applicant's co-pending application entitled “Method and System for targeted Advertising”, methods were shown for matching content to opportunities, and for using multiple parameters for the weighting. In addition to the mechanisms and parameters described in that filing, information, methods and parameters are available within existing receiver implementations that can be used for content targeting.

Location information can be stored on digital receivers in the form of a zip or postal code, or a value derived from the zip, postal code or customer address to determine location, and is used to determine time zone for clock display and scheduling functions, and as a geographical access control system for blackouts. Rudimentary profiles are available for presenting customized versions of the EPG to various users of the receiver, or to restrict accessible content for certain users. Modes and rating flags are set to lock out programming based on program rating (VCHIP), selected profiles, and categories of operation like pay-per-view purchases. Pay-per-view purchase histories are stored until they can be reported back to the operator.

Using this data allows simple targeting methods in existing receivers without having to implement additional data storage and related security for the targeting system. The data may also be used in conjunction with other data provided and managed specifically for content targeting purposes. The EPG profile currently in use can be added as a parameter to the viewing record to aid in identifying a particular user of the receiver.

The applicant's co-pending application entitled “Method and System for targeted Advertising” provides mechanisms for determining the probability that a given user or group of users will be watching a given content stream (channel) at a given time, and can schedule and value the delivery of advertisements based on the probability. This invention provides mechanisms for a plurality of transmission mechanisms for the various versions of content for targeting opportunities, as well as a plurality of receiver capabilities. Another vector and weighting factor can be added to the matching calculations to include the likelihood that a receiver will be able to watch the content when it is transmitted using a given network mechanism. In this way, and advertiser or programmer can assess the value of adding an additional version of the advertising or content because a desired demographic group may be more likely to have acquired a receiver with dual tuners and/or fast Internet access.

The blackout mechanisms are implemented using geographical area definitions, which are transmitted and matched to the receiver's location. Blackouts are divided in to categories, and there may be a category for each sport, league or even team within a league. For each category, the operator's coverage area is divided into zones. For each category, the receiver belongs to a specific zone. Various mechanisms are available for defining the categories and zones and transmitting the information to the receivers, and these are known to those of skill in the art.

Through use of the existing blackout zone definitions, the matching algorithms are provided with geographical coverage areas that can be used to match content to users. Using the same mechanisms, additional categories which are not related to sports can be created to be used solely for content targeting.

Content Recording and Copy Protection Mechanisms

Current implementations of video copy protection schemes involve the modification or addition of components of the video to prevent recording on VCR devices. In analog video transmission, the modification is performed by the operator on the transmitted signal. In digital video transmission, data transmitted with the video, usually in the form of a true-or-false value, indicates that the receiver, when playing out the video, must perform the video component modification to prevent connected VCRs from recording the content.

The copy protection scheme is extended to receivers with digital storage to encompass the capabilities of the storage by assigning additional meaning to the copy protection flag. When the transmitted video has an indication of copy protection, the flag can include any or all of the following meanings:

The receiver is not permitted to record the content to storage

The receiver is permitted to hold only enough content in storage to allow a pause feature to be implemented. The pause feature may also include a limited amount of rewind time

The receiver is permitted to record the content to storage, but only if encryption facilities are available. The encryption and subsequent decryption and playback, may require the facilities of the conditional access system.

Limitations may be placed on the playback, including time limits and number of replays

The receiver must include analog copy protection mechanisms within the video signal to prevent recording on VCRs

The ability to record and replay and the time limits and number of replays may be subject to permissions assigned by a conditional access system, or as part of rights acquired during the purchase of a pay-per-view event.

As the current copy protection model is based on a binary true-or-false value of the copy protection flag, the copy protection flag can also be extended as a series of flags or as a data structure with multiple fields to allow explicit specification of any or all of the copy protection features listed herein.

In the case where storage is located on a network facility, the storage may be shared by a number of receivers. A request to store content is compared to other requests, and if another request has been made to store the same piece of content, the request is ignored. However, a record is made of the multiple requests, and the content is not deleted until either all requestors have issued a delete request or the temporal limits on the recording or the associated permissions have all expired.

During the recording process, the content being recorded may include one or more content targeting opportunities. Depending on the attributes described earlier in this invention for selecting targeted content, including the use of specific attributes or the receiver's capabilities, any or all of the following may be implemented in the content recording process:

The inclusion in the recording of all of the opportunity and content descriptors, to allow the selection of targeted content to occur during playback as it would during live airing

The recording of the content with the selection of content during opportunities being the same as that which would be made if the content was being watched live

The recording of the content with an alternate selection based on one of the variable within the matching process being an indicator of whether the content is being watched live, recorded, or watched while being recorded

If the matching process includes a characterization of “watched while being recorded”, then the version of content that is being shown to the watching viewer may be different from the version of content being recorded, provided this capability is available within the receiver.

The selection of an alternate version of content specific to an event being recorded can be implemented whether or not the recording feature is integral to the receiver. In one embodiment, the record feature consists of deferred record function available to a user on a receiver, which, when activated, consists of changing to a selected channel near the time of the start of a program, and the control through infrared signals or other protocols of an external recording device. The state of the receiver during the record process can be recognized and used as an argument within the matching algorithm.

Targeted Content Presentation

The following section contains more detailed information on aspects of the invention particularly related to the presentation of the targeted content

The present invention is directed to a method and system for targeted content presentation in a communications network.

In accordance with the present invention, there is provided a method for targeting content to users in a communications network; the method comprising the steps of determining targeted user characteristics and presenting content in accordance with said characteristics.

In accordance with the present invention, there is further provided a method for targeted content presentation in a communications network for regularly scheduled content opportunities, the method comprising the steps of: monitoring the programming stream for opportunities and content descriptors; determining the source for alternate content; matching the opportunity to the available content and the viewer characteristics; presenting In one embodiment, the system includes a delivery engine, a matching engine, a combiner, and a micro decision engine (MDE).

The matching engine, delivery engine, and combiner are located at one or more facilities head-end, while are located at network points and/or on receivers connected to viewing devices such as televisions and personal computers.

The matching engine is responsible for generating schedules, meta-data and triggers that, combined with content, are broadcast via the delivery engine to MDE's. The matching engine also communicates with the delivery engine to forward configuration triggers that inform an MDE of a requirement to replace particular MDE sub-components in part or in whole.

The delivery engine is located at network broadcast points and is responsible for ensuring the coordination and delivery of profile data and content. The delivery engine can be deployed across a plurality of hardware platforms at one or more points to support load balancing and capacity planning needs.

The base MDE can either be embedded within receiver software or streamed out by the delivery engine and loaded onto receivers from the broadcast stream. The base MDE examines its receiver environment for available functionality, and can use this information to load additional constituent sub-components.

The invention uses data management and broadcast techniques that map to a broadcast environment to provide desirable targeted content delivered to subscribers' receivers without requiring subscriber interaction. The system provides targeting of content based on a balancing of receiver capabilities and/or viewer profiles.

The delivery engine sends meta-data and triggers, via the combiner, through the broadcast network to the MDE for the purposes of targeted content delivery and presentation. System middleware elements collect information from the combiner that broadcasts reporting meta-information to the receivers using standard broadcast equipment such as MPEG2 multiplexers and encoders.

MDE's are responsible for “understanding” regular broadcast schedules, setting up and managing demographic profiles, recognizing functional opportunities described as user interactions, collecting appropriate targeting content, and storing selected content on the receiver. MDE's make final decisions on how best to provide targeted content to the viewer. Opportunities for targeting content are created at network operator sites and are sent to collections of digital receivers for processing and presentation of targeted content. Targeting opportunities can also be provided at the receiver, and are the subject of the Applicant's pending application filed Oct. 13, 2000 Ser. No. 09/687,449 entitled “Method and System for Targeted Advertising”.

In an embodiment of the present invention, the system can further include a reporting component for providing updated profile information, and is the subject of the Applicant's co-pending application entitled “Method and System for Automated Reporting in a Communications Network”. In this reporting embodiment, the MDE is further responsible for creating and managing audit logs for reporting back on user viewing data.

The MDE receives profile information on viewers from the matching engine using the delivery engine. The matching engine manages and controls the delivery of such information received from broadcasters and multiple services operator; information that can be based on subscription information provided to the operator by the viewer and/or information the operator has acquired from other sources. The viewer profile data can be forwarded in encrypted or unencrypted format. In an embodiment of the present invention, the data is kept in encrypted format within the facilities of a conditional access system to prevent unauthorized access, as would be known to persons skilled in the art. In this way, the processing may prohibit the retrieval of data by unauthorized functions or functions outside of the secure facilities, with only the results of the match returned to the requesting method.

The MDE collects targeting content, profile information and schedule information, prepares its work environment, and can be dynamically modified on any given receiver to provide real-time updates, thereby dynamically adapting it to the receiver and to particular broadcast environments. Content targeting occurs on each receiver according to the features available on that receiver.

MDE updates are embedded in metadata regularly broadcast to receiver components. New and/or additional MDE's can accommodate different receiver capabilities, middleware systems, application execution environments, network technologies and bandwidth, security systems, network operator requirements thereby supporting multiple heterogeneous infrastructures and varying receiver capabilities. Multiple instances of the MDE can be generated to match technology and requirements.

Metadata carousels present descriptions of available targeted content. Carousels are the subject of the Applicant's co-pending application entitled “Method and System for Dataflow Management in a Communications Network”. The most up-to-date versions of MDE's are delivered across carousels, and can replace themselves at any time with a more appropriate MDE, or can remain resident on the receiver. An MDE configuration can be changed dynamically using the matching engine that directs the system to multicast the appropriate MDE.

The targeting of content is broadly defined as the exploitation of opportunities to present viewers with one of a number of alternative versions of content. Targeting opportunities can be based on segments of content that can be substituted for alternate segments, based on dynamic alteration of the content, and on presentation based on the invocation of functions by the user.

Storage of targeted content can be provided on receivers in the form of persistent storage, if such facilities are available on the receiver, and/or can be provided in the form of temporary storage. MDE's are preferably located on receivers, but can be located on other intermediate network components in situations where limitations exist with receivers or where appropriate based on network characteristics or both. Since there are a variety of application platforms used by receiver vendors, the implementation of the MDE is tailored to a particular platform, with each platform having its own version of an MDE.

Content from the server can be transmitted in real-time, or slower or faster than real-time to cache content for deferred viewing. Content may flow into pre-processing devices that pre-process the content before distribution such as encoders, encryption devices, and packetizers. From these devices, the processed content flows into a combiner for delivery, through a network interface to via a network for delivery to a plurality of receivers.

In an embodiment of the present invention, the configuration for the MDE is based on demographic parameters such as geographical location and/or postal codes. In addition to receiver information, algorithms within the MDE can access the demographic parameters themselves, which can originate from the head-end and/or from data obtained or derived from viewer interaction.

The invention is capable of functioning in receivers lacking persistent storage capabilities. As well, the invention enables the management and synchronization of targeted content delivery across heterogeneous networks, by adapting receiver-based targeting applications to receiver and supporting network environments. The invention provides allocation management of resources on the receiver in an environment where multiple interactive services may be competing for the same resources like disk space and memory storage.

Physical embodiments of receivers include digital set-top cable and satellite receivers; integrated components within digital televisions; personal computers with appropriate network connections, gaming consoles, and cellular telephones and personal digital assistants connected through wireless networks and occasional computer network hook-ups. A receiver's functions may be contained within local equipment or distributed throughout a network. For example, when using xDSL equipment or the Internet, a channel change request to a set-top receiver can send a signal to control equipment on the operator's network, which changes the program stream being transmitted to the receiver, operating alone or in combination.

Content includes audio, video, data, applications, or any combination thereof, which is made available to a viewer by broadcast or point-to-point transmissions or requests for content. Examples of content include television or radio programs, computer games, images, and news and stock tickers.

When an opportunity for content targeting is presented, appropriate content is selected to exploit the opportunity. In this way, the content the viewer receives can be specifically tailored to the viewer and/or receiver type, without the tailoring and selection process necessarily being apparent to the viewer. While user input is not required, data and preferences entered or selected by the user can be incorporated in the process.

In an embodiment of the present invention, an opportunity is provided by advertisements located at pre-determined points within a television program. Viewers selecting the program see the same program, but may receive different versions of advertisements based on parameters set by the broadcaster. The locations of advertisements within the program can be relative to the start of the program or based on a trigger in the program stream, so that the opportunities can be used whether the program is broadcast live or replayed from storage.

In an embodiment of the present invention, scheduled segments within a television program provide the opportunity, and the segments the viewer sees are based on parameters selected by the broadcaster. For example, during a news show, a specific section of the show allows the viewer to see more business, sports or entertainment news, based on the viewer's preferences.

In an embodiment of the present invention, the opportunity can be provided by information within a game, graphical application or video program that allows a portion of the content to be replaced. For example, a baseball video game or program can include a background billboard, which is used to display an advertisement, in still or moving video form. The advertisement is selected based on parameters and functions set by the programmer.

In an embodiment of the present invention, an opportunity is provided by the invocation of a receiver function by the viewer. Examples of function-based opportunities include the triggering of content display when an electronic program guide (EPG) function is selected, or when playback, application or game control functions such as ON, OFF, FF, REW, and PAUSE are used on appropriately equipped receivers. The algorithm for assessing the opportunity not only matches the content to the opportunity, but also determines if the opportunity will be exploited in this invocation by assessing the timing of prior function invocations. In an embodiment when the viewer first turns on the receiver, a short advertisement that has been cached on the receiver is displayed before other content can be viewed. Use of other functions like PAUSE or PLAY can result in ads being played, with the ad designed to match the opportunity.

Metadata includes content information, information on opportunities for presenting the content, and information and processes for matching content to opportunities. Metadata and content are transmitted to digital receivers. The metadata is contained in existing or new transmission structures and facilities, and relates to the co-transmitted content or to content available from other sources, synchronously or asynchronously.

Management methods in the storage manager component of the MDE monitor the transmitted stream and provide storage and storage management mechanisms for alternate versions of content, acquire content from alternate sources, control access to the storage and data, and securely acquire, store and retrieve characteristic information used in the selection process.

Presentation methods in the presentation manager component of the MDE display the content based on opportunity information from the transmission stream, opportunities created by function invocation by the user, physical and temporal content availability, and processes for matching the content to the opportunities. The matching process may have complex requirements including multi-service broadcaster requirements, multi-message content sequencing, and user preferences including ratings and permissions such as those used in implementations of technology used to broadcast ratings with the programming and allow receivers to block viewing of programs with ratings deemed inappropriate. Combinations of all of the above methods provide precise timing and event synchronization capability for the presentation of content.

Table 1 shows a list of content and related characteristics. The content type 81 enables the receiver to determine if it is capable of showing the content. For example, alternate versions of a single ad may be available as different audio/video clips or as a graphical application with interactivity options. A receiver without interactivity can ignore the application version. The type can be represented as a value or as a data structure representing complex options within the piece of content. In an embodiment of the present invention, the data structure can be represented as a data structure showing both the properties and the requirement for presenting those properties. As shown in Table 2, clip “Ad 1 with optional interactivity ” indicates that audio, video and interactivity are present in the clip, but interactivity is not required. A receiver not equipped for interactivity could still show only the audio and video. Clip “Ad 2 with mandatory interactivity” has audio and video that is directly tied to the interactive component, and is not to be used by this type receiver.

TABLE 1
list of content and related characteristics

| Content | | | Content | |
|---|---|---|---|---|
| identifier 84 | Description | Content type 81 | Source 82 | Content charadteristics 83 |
| 1111 | Ad 1 with optional | Audio = yes, | Channel | Area = California, type = tv ad |
| | interactivity | video = yes,ATVEF | 204 real | |
| | | interactiviy = yes | time | |
| 1112 | Ad 2 with mandatory | Audio = yes. | Channel | Area = MidWest, type = tv ad |
| | interactivity | video = yes,ATVEF | 205 real | |
| | | interactiviy = yes | time | |
| 1113.1 | Ad 1 of 3 for new car | Audio = yes, video = yes | Internet | Area = everywhere else, |
| | model | | | type = tv ad |
| 1113.2 | Ad 2 of 3 for new car | Audio = yes, video = yes | Internet | Area = Northern states, |
| | model | | | type = tv ad |
| 1113.3 | Ad 3 of 3 for new car | Audio = yes, video = yes | Internet | Area = Southern states, |
| | model | | | type = tv ad |
| 1114 | Ad 1 for play during | Audio = no; video = yes, | Channel | Area = all, type = pause ad; |
| | pause | ATVEF interactivity = yes | 206 14:02 | duration = 30 |
| 1115 | Ad 2 for play during | Audio = no; video = yes, | Channel | Area = all, type = pause |
| | pause | ATVEF interactivity = yes | 206 14:04 | ad, interruptible = no |
| | | | | duration = 5 |

The content source enables the receiver, based on its capabilities to determine if content is accessible. Content characteristics describe targeting attributes of the content. The number and types of characteristics are dynamic and can grow or change over time, as would be known to persons skilled in the art. Content characteristics can include temporal sensitivity includes the maximum or minimum showings per time interval, minimum intervals between showings or a time window in which the content can be used, repeatability such as maximum number of showings, characteristics for matching the content to the opportunity, conditional access system control information, opportunity type, and access rights to identify the source of the content.

Use of access rights is particularly important for operators, as fees and technical considerations may be required for the operator to allow the application to be transmitted. As an example, commands for network callback may be contained within the interactive stream, but not permitted for all applications based on access rights available to the specific MDE/receiver. The access rights will be generated by the operator or the matching engine and streamed to the MDE.

The content identifier is a unique code used for storage, and retrieval and for reporting content usage. The identifier can further include a sequence component to indicate that the content in question is one of many in a series, and its sequence within that series.

Access rights within the characteristics are used to ensure that the content, and in particular its use of resources like storage, and network and processing facilities is appropriate to the receiver and the operator's network(s). Message encryptors can be used and are commonly implemented in conditional access and Internet systems, and implementation details will occur to those of skill in the art.

Table 2 shows a list of content display opportunities. The opportunity type describes how the content display opportunity is initiated. Mechanisms include an absolute schedule with a time at which content must be presented; a relative schedule having a time relative to another event or trigger, and a function invocation where the use of a feature on the receiver can trigger the display of content.

TABLE 2
List of content and related characteristics

| | Opportunity | | | | |
|---|---|---|---|---|---|
| Opportunity type | Content 86 | Opportunity | Opportunity | Opportunity | Opportunity |
| 85 | Source 82 | Context 87 | method 89 | descriptors 90 | identifier 88 |
| Type = absolute | 1111,1112 | channel = CNN; | geography | | 2111 |
| time; time = (14:02; | | | match | | |
| 14:04) | | | | | |
| Type = relative | 1111,1112 | channel = (CNN,H | Income match | 1111 if < | 2112 |
| time; time = (triqqer | | NN, CNNFN); | | 100000; | |
| 2112 + 300 | | | | 1112 if >= | |
| frames) | | | | 100000 | |
| Type = function | 1113.X | function = on; | play all in | | 2113 |
| | | | sequence | | |
| Type = function | 1114, 1115 | function = pause | match to | | 2114 |
| | | return | pause | | |
| | | | duration | | |

The opportunity content list shows the content that can be selected for display. This field is related to the content identifier of Table 4. The opportunity context determines when and where the content is to be displayed, a specific stream where the content can only be displayed on a given service, a group of streams where the content can be displayed on any one of a plurality of services, a time window for function invocation where the content is to be displayed if the user hits the PAUSE button between contains times, or the invocation of a function on the receiver such as a channel change.

The opportunity identifier uniquely identifies the opportunity for reporting purposes. Function invocations are based on viewer input through receiver controls, including switches on the receiver, remote controls, mice, keyboards and other input devices, and commands and trigger signals sent with the video; commands sent across a wired or wireless network through other devices. Opportunities are tailored for a receiver's capabilities, and can be based on the invocation of a series of one or more functions, and/or the timing and context of the function invocation. A result of a condition test involves the execution of a complex function in which a variety of conditions can occur based on data from the network and input from the user.

Algorithms can be designed to use multiple facilities to ensure a high probability of showing a sequence of content within a give timeframe with a high degree of independence of the content being watched. For example, a content provider with multiple services can request that a series of advertisements be presented in sequence between 20:00 and 22:00, taking advantage of opportunities occurring on all their services from function invocation. For each advertisement in the series, multiple versions can be available, and the matching algorithms for the opportunities will make the appropriate selection.

The opportunity method used by the MDE indicates which method should be used to match the opportunity to the content. The method can be a reference to a function available in the MDE or receiver, a function that is acquired from the network, a function that is included in the opportunity descriptor, or a combination of these with the appropriate method or combination of methods being selected based on the capabilities of the receiver and connected network.

In an example, the opportunity with description Ad insertion when user returns from PAUSE in Table 5 uses method match_to_pause_duration, and the selection is based on the viewer returning to viewing after selecting the PAUSE function. This method is designed to minimize the annoyance of the user, and is based on the duration of the PAUSE and the time since PAUSE was last used. The results of the algorithm are that the ad will not be shown if there was a return from PAUSE in the last 5 minutes. If the PAUSE was used within the last 30 minutes, then an ad will be selected that is less than 10 seconds in length. If the PAUSE has not been used in the last hour, then an ad of 30 seconds or less will be played.

The opportunity descriptor is a data set that matches viewer group characteristics with a probability for each viewer group to be a viewer during the opportunity. Processes and methods for this type of match can be found in the applicant's co-pending application entitled “Method and System for targeted Advertising”. As is the case for content descriptors, the opportunity descriptors can include encrypted components using the necessary encryption and decryption schemes.

As described in prior art, multiple versions of a television channel can be transmitted synchronously, and using a variety of mechanisms based on user input, the receiver can switch between the different channels to create a custom version of the program.

This invention enables several mechanisms for synchronous content transmission. One method involves synchronization of multiple streams of unrelated content. The streams are related only for targeting purposes, and not by their content. Each stream has different ads, however the timing of the ads is synchronized across the streams. At the start of each ad, the receiver can switch to a different channel for the duration of the ad if the ad on the other channel is determined to be more appropriate, or if it is a version of an ad that has not been seen by the viewer.

Another method involves adding additional streams for alternate versions of the content. As in the first method, the streams are linked to a plurality of content streams that are related only for management purposes, and not by content. By scheduling advertisements at different times on the content streams, the alternate content streams can be shared among the principal content streams.

Another method makes capacity available by manipulating content streams to eliminate redundancy caused by simultaneous substitution on networks where regulations require that when the same program is broadcast simultaneously from a local provider and a foreign provider, that the local provider's program replace the foreign provider's program on the foreign channel broadcast. Current network implementations result in the local program being transmitted redundantly on both channels.

Another method makes capacity available by placing content on services that are not broadcast 24 hours a day. During the off periods, the bandwidth of the services can be used either within the service definitions, or as separate services that use the bandwidth resources of the off-air services.

In switched environments such as DSL networks and video speed Internet with sufficient pre-roll time content can be queued and selected at the appropriate time. Within xDSL and Internet environments, a single stream of content can be multicast to a plurality of receivers.

For asynchronous content transmission, any of the network mechanisms discussed, broadcast or point-to point can be used. Content on these networks can be transmitted in real-time, or slower or faster than real-time at fixed or variable speeds at alternate times, using transmission formats different from the normal video transmission. For example, a satellite stream for alternate content being transmitted asynchronously may consist of broadcast TCP/IP file transfers within DVB streams, instead of the MPEG-2 packetization normally expected of video streams.

Once the presentation of an alternative piece of content has started, the display of the content may or may not be interrupted by the use of functions like channel changes. A characteristic of the content or the opportunity can deem the content to be uninterruptible, in which case the content will play to completion before other functions are allowed to proceed. Another characteristic is conditional uninterruptability, in which case the content can continue to play if certain conditions are met. In the case of multiple content channels with synchronized ad start times described earlier, a change to one of the channels in which the opportunity is being co-coordinated would continue to play. Certain characteristics have priority over others, or a hierarchal structure.

A broadcaster or network operator typically must support multiple receiver and network types for the distribution of their content. The invention supports multiple network and receiver hardware and software combinations. Each of these possible combinations is referred to as a delivery model. Delivery models can be supported as elementary targeting mechanisms, where advertisers and broadcasters can choose to deliver content based on the capabilities of groups of receivers and their respective networks.

At the matching engine and delivery engine levels, the system retains and uses information about each delivery model and the various components of the distribution network. Information can include logic execution capabilities and specifications, network latency for specific services and equipment that affect presentation timing, receiver types and features, including memory, local and network storage, network connections and capabilities. Information can further include data available to receivers, bandwidth for delivery to receivers, number of receivers within each delivery model, viewer characteristics for each receiver. This information is used for purposes such as consolidating feedback from network and receiver components into a common format for reporting to networks, advertisers and other parties, generating the algorithms for transmission to the receivers, management of and scheduling of transmission such as timing and bandwidth. The heterogeneous network support allows for the physical separation and independent management of components.

Matching engine functions can be located at broadcasters or other content providers, and can communicate with multiple delivery engine functions at other broadcasters and network operators. Network operator matching engines and delivery engines can in turn be receiving targeting information from multiple broadcasters and content distributors.

In applicant's co-pending application entitled “Method and System for targeted Advertising”, methods were shown for matching content to opportunities, and for using multiple parameters for weighting. Further information, methods and parameters are available within existing receiver implementations that can be used for content targeting.

Location information can be stored on digital receivers in the form of a zip or postal code, or a value derived from the zip, postal code or customer address to determine location, and can be used to determine time zone for clock display and scheduling functions, and as a geographical access control system for blackouts.

Rudimentary profiles are available for presenting customized versions of the EPG to various users of the receiver, or to restrict accessible content for certain viewers. Modes and rating flags are set to lock out programming based on program rating, selected profiles, and categories of operation like pay-per-view purchases. Pay-per-view purchase histories are stored until they can be reported back to the operator.

Using this data allows simple targeting methods in existing receivers without having to implement additional data storage and related security for the targeting system. The data can also be used in conjunction with other data provided and managed specifically for content targeting purposes. The EPG profile currently in use can be added as a parameter to the viewing record to aid in identifying the actual viewer within a plurality of viewers using the receiver.

Blackout mechanisms are implemented using geographical area definitions are transmitted and matched to the receiver's location. Blackouts are divided into categories, and there can be a category for each sport, league or even team within a league. For each category, the operator's coverage area is divided into zones, the receiver belonging to a specific zone. Those of skill in the art know various mechanisms available for defining categories and zones and transmitting information to receivers.

Through use of existing blackout zone definitions, matching algorithms are provided with geographical coverage areas that can be used to match content to viewers. Using the same mechanisms, additional categories unrelated to sports can be created for use solely for content targeting.

In an embodiment of the present invention, a viewer profile includes a restriction on violent content. Presentations methods can take steps including assuming with a high probability that the viewer is a child based on the rating and channel selections in the provide, show an ad for a children's movie as opposed to an action or adult movie at the next opportunity to show an advertisement for a pay-per-view movie, report the likelihood of the ad having been viewed by a child when reporting back on the viewing result.

Resource management capabilities can be leveraged by entities owning or managing receivers for customers to control access to individual services, resources and/or information. This is particularly important when information is considered confidential to the viewer and should not be accessible to every interactive application transmitted to the receiver. The MDE can work with existing conditional access infrastructure to determine whether or not the MDE is authorized on behalf of a requesting agency to access those desired resources by taking into account the status of the requesting agency, as well as the nature of the request.

The basic MDE's structure is independent of receiver middleware, thereby providing a highly adaptive system that enables real-time upgrades to component features and performance characteristics to enhance or modify content targeting features without the need for middleware upgrades, providing enhanced flexibility and decreased maintenance costs. This flexibility enables the invention to be deployed in environments including cellular telephony networks, cable networks, IP-based networks, and consumer kiosks such as automated teller machines.

The invention dynamically adapts targeting and selection mechanisms to meet the changing needs of programmers and advertisers. Further, the MDE can interact with conditional access systems to provide authentication, authorization and privacy.

Security and authorization are provided by the conditional access system (CAS). The CAS determines what content the viewer is allowed to access. The CAS can include a content encryption system for protection of the content during transmission, permission management for control of authorizations on a per user or receiver basis, content management for controlling access to content, a message encryption facility to secure communication authorization and other messages for transmission, and a receiver component for communications with the operator's CAS and local secure storage of permission and content access information.

The invention uses existing commercial broadcasting infrastructure to deliver targeted content, providing network infrastructure operators with the ability to deploy the system on existing environments with little or no additional expenditures. The system is dynamically adaptable, providing such things as new reporting algorithms, improved functional capability, and component code fixes in real-time and in an automated manner.

The invention provides the ability to manage targeted content delivery through multiple elements of broadcast activity, from the placement of content from broadcasters and their proxies, through to multiple cable and/or satellite distribution networks, to the receiver at the customer premises. As well, in embodiments of the present invention, the system can feed back reporting data to appropriate head-end systems to improve targeting accuracy. The invention utilizes data management and communications techniques that are system-independent, enabling a head-end broadcaster to deploy a single solution across their entire network that may comprise infrastructure and receivers embodying a variety of incompatible systems.

Dataflow Management

The following section contains more detailed information on aspects of the invention particularly related to the management of various dataflows within the system.

The present invention is directed to a method and system for dataflow management in interactive communications networks.

In accordance with the present invention, there is provided a method for dataflow management in interactive communications networks, the method comprising the steps of: determining characteristics of network components; and managing dataflow in accordance with said determined characteristics.

In accordance with the present invention, there is provided a method for targeting content to users in a communications network; the method comprising the steps of: determining targeted user characteristics; and presenting content in accordance with said characteristics.

The invention is suitably used with Cellular telephony; Cable networks; Consumer kiosks such as ATMs; DSL; and IP based networks.

The viewer data can be received in encrypted or unencrypted format. In this embodiment, to prevent unauthorized access, the data will be kept in encrypted format within the facilities of a conditional access system (CAS). Multiple instances of the Micro Decision Engine (MDE) can be generated to match both the capabilities and requirements of the combiner, and the capabilities of the various receiver models on the network.

The DE communicates with head-end hardware to orchestrate the delivery of targeting information to the MDE. Targeting information includes bandwidth availability, parametric data, selection triggers real-time cues, decision-making applications and timing and synchronization information from sources such as internal clocks, external reference clocks and time, relative time from triggers within content sources, and derived time from activities such as MPEG-2 video compression timing streams. It can also provide the head-end's broadcast systems with the schedule for the streaming of default or prime ads within broadcast video streams.

The DE determines the optimal method of delivering the package(s) to the MDE using techniques such pre-time, just-in-time and repeated transmission of the packages to ensure that the MDE has sufficient choices and time to acquire content, to make an appropriate match and present the data. Before transmitting the data it will ensure that the meta-data describing the matching requirements are suitable for the target MDE's. The DE using data/object carousels and/or other data transport mechanisms sends meta-info data. The structure of the carousel will be a contract between the DE and the MDE. The Matching Engine and the DE combine to decide the relevance of targeting information in the carousel. Understand and manage latencies in the delivery processes, such as creation of carousels.

The combiner is responsible for providing the delivery engine with a means to communicate with a network system for the purposes of streaming targeting content and applications. It understands how to create a middleware specific object carousel (OC), which is what will be delivered to the MDE by the broadcast system. This component provides a standard interface to the delivery engine for different Ad Carousel Management and delivery systems. This component isolates the delivery engine from implementation specifics of Ad Carousel systems. The delivery engine uses the combiner component to generate OC based on Ad dependant data such as the information generated by the OPE and Ad independent data.

In an embodiment, the content is an audio and video signal from a broadcaster, and the encoder is an MPEG-2 compressor which converts the signal from analog to digital format and then compresses and synchronizes the components into MPEG-2 data streams. The aggregator is an MPEG-2 multiplexer that creates a multiplexed transport stream delivered to the network interface, which in this case is a modulator appropriate to a cable television network. The network is the system of amplifiers, transmitters, re-transmitters, copper cable, fiber optic systems, switches and routers used for distribution of the signal. The receivers are connected to the cable network, and communicate back with the operator using Internet and/or other command protocols supported by the network.

A receiver's functions and facilities can be contained within a receiver on the viewing premises or distributed throughout a network. The receiver can have a plurality of content processing systems (CPS). Each CPS requires a network interface for communication to and from the operators' network(s), a decryptor for deciphering any secured information, a decoder for converting from the network format to the viewing or usage format, and a processing element for handling any instructions, graphics processing, multi-media combining or other formatting required before presentation to the user. A management system co-coordinates the operation of the various functions. Content storage is used to record information pertinent to the usage of the system, and for content storage and playback.

Before allowing content to pass through the decryption, decoding and other steps required for viewing or usage, the management system can communicate with the CAS to determine if access is allowed or to obtain access through purchasing or other mechanisms, as is typical in impulse pay-per-view purchases. The CAS process can include protected storage, processing and processes, access to which can be restricted through interfaces and protocols. Separate encryption and decryption facilities can be included for secure management of communications to and from the CAS.

Other examples of CAS include digital television conditional access systems implemented with individual encryption of each content stream, encryption key generation systems, command and authorization streams which are also encrypted, and capture, decryption and storage of CA permissions within the receiver or separate facilities such as a smart card within the receiver. Systems for managing commercial transaction may provide similar functions to the CAS in the receiver, operating in separate facilities or integrated with the CA CAS system. As another example, the receiver can perform an authorization check whenever access to content is requested, as implemented on switched packet networks using TCP/IP, ATM and other protocols, including the Internet and various authorization schemes supported by servers, and digital subscriber line (DSL) distribution networks, including the ADSL, VDSL and other implementations. Other security systems and authorization mechanisms will occur to those of skill in the art.

For example, when using xDSL equipment or the Internet, a channel change request to a receiver sends a signal to control equipment on the operator's network that changes the program stream being transmitted to the receiver. Embodiments can include a plurality of content processing systems, for example a receiver may have multiple processing streams to allow simultaneous processing of multiple streams for picture-in-picture viewing, watching one program while recording another to storage, or surfing the Internet while watching a television program. Storage may be included in the receiver and/or available from a network resource.

In another embodiment, content storage, CAS facilities and other functions of the receiver can be provided or augmented by sharing resources among one or more receivers and equipment accessible to receivers on a network within the viewer's premises. Individual receivers can share disk space among them, personal computers on the network can receive alternate versions of content that can be selected by the targeting and matching processes, and storage on the personal computers can be used to record content. Authorization, logging and other facilities may be performed on one device for other connected devices.

Embodiments of the processing and management components can receive, process and present to the viewer applications that integrate text, data, graphics and audio/video content, interact with the user for input, and provide feedback across a network connection. Implementations can take the form of an embedded software system with required functions, an operating system with integrated functions, or applications and libraries accessible to an operating system or embedded system.

In one embodiment, content and opportunity descriptors are provided as data in a joint stream or in separate streams to a process on the receiver. The format is appropriate to the network, and examples include DVB TCP/IP streams on a satellite network and an IP data-casting stream on the Internet. Multiple instances of descriptor and content streams can occur, each associated with a content service like a television channel, or the content streams can be in streams independent of the content service.

In another embodiment, the content and opportunity descriptors are included in the vertical blanking interval or other portion of the video signal as is done today for closed captioning, teletext and analog TV ATVEF transport A, or MPEG mechanisms for carrying closed captioning fields and related data within picture headers and control information.

In another embodiment, the content and opportunity descriptors are included in interactive content streams as data, functions, functions with parameters, and/or function calls to functions already stored within the receiver.

In another embodiment, the content and opportunity descriptors are included in fields within other tables and Service Information (SI) structures of the underlying medium. Within DVB systems, the content and/or opportunity descriptors can be carried in one or more private descriptor fields of the Event Information Table (EIT) carrying EPG content.

Content and opportunity descriptors are not necessarily transmitted separately. In a simplified implementation, the content and opportunity descriptors can all be included within a function call, with the function representing the method of the opportunity descriptor.

As described in prior art, multiple versions of a television channel can be transmitted synchronously, and using a variety of mechanisms based on user input, the receiver can switch between the different channels to create a custom version of the program.

This invention enables several mechanisms for synchronous content transmission. One method involves synchronization of multiple streams of unrelated content. The streams are related only for targeting purposes, and not by their content. Each stream includes different ads, however the timing of the ads is synchronized across the streams. At the start of each ad, the receiver can switch to a different channel for the duration of the ad if the ad on the other channel is determined to be more appropriate, or if it is a version of an ad that has not been seen by the viewer.

Another method involves adding additional streams for alternate versions of the content. As in the first method, the streams are linked to a plurality of content streams that are related only for management purposes, and not by content. By scheduling advertisements at different times on the content streams, the alternate content streams can be shared among the principal content streams.

Another method makes capacity available by manipulating content streams to eliminate redundancy caused by simultaneous substitution on networks where regulations require that when the same program is broadcast simultaneously from a local provider and a foreign provider, that the local provider's program replace the foreign provider's program on the foreign channel broadcast. Current network implementations result in the local program being transmitted redundantly on both channels.

Another method makes capacity available by placing content on services that are not broadcast 24 hours a day. During the off periods, the bandwidth of the services can be used either within the service definitions, or as separate services that use the bandwidth resources of the off-air services.

In switched environments such as DSL networks and video speed Internet with sufficient pre-roll time content can be queued and selected at the appropriate time. Within xDSL and Internet environments, a single stream of content can be multicast to a plurality of receivers. Any network mechanisms can be used for asynchronous content transmission. Content on these networks can be transmitted in real-time, or slower or faster than real-time at fixed or variable speeds at alternate times, using transmission formats different from the normal video transmission. For example, a satellite stream for alternate content being transmitted asynchronously may consist of broadcast TCP/IP file transfers within DVB streams, instead of the MPEG-2 packetization normally expected of video streams.

The asynchronous acquisition of content is based on the capabilities of the receiver, and can be done in parallel with viewing activities, and/or when there is no viewer usage of the receiver. In one embodiment, a satellite or cable receiver with disk storage capability and a single content processing system can use the receiver tuning and acquisition facilities when the user has indicated that the receiver is not being used by pressing an OFF button, or when the viewer is watching content from the disk drive instead of content from the satellite.

In another embodiment, a satellite or cable receiver has the functionality dual content processing systems for record-while-viewing and picture-in-picture capability. If neither of these capabilities is being used, then the receiver can acquire content anytime. In another embodiment, a satellite or cable receiver also has Internet access of sufficient speed to acquire content from the Internet given a sufficient amount of time to accommodate speed and latency delivery problems.

The receiver management methods are processes for accessing, retrieving, storing and deleting content and data. Embodiments of the receiver will vary in their capabilities, and in particular in the number of instances of the content processing system. Embodiments of the receiver can acquire content descriptors and content based on the transmission methods described earlier, and will vary based on the implementation of the receiver. Examples of content descriptor acquisition include the following:

As part of a completely independent content acquisition stream, this method requires that the receiver either be equipped to handle a separate stream other than the viewed stream, or that the content from such a stream be acquired when the receiver is not used for viewing. In a cable or satellite receiver, this requires component(s) to provide separate frequency tuning, demodulation and decrypting functions, or access to another source or technology like the Internet, as part of a co-located stream that can be processed while content is being viewed, as part of a dynamic stream that includes both content descriptors and content opportunities, as part of a response to a viewer request for content, in which descriptions of alternate versions or segments of the content are included by sending a message directly to the receiver.

The management method also receives characteristic information on the viewers from the operator. This data may be based on the subscription information provided to the operator by the viewer, or information the operator has acquired from other sources. When an opportunity for targeting contents results in the switch from one content stream to another, whether the content is from another stream, storage or another source, the system must switch as seamlessly as possible from the original to the alternate stream.

Access to an alternate stream may not be instantaneous. Preparation required before switching streams can include locating and retrieving content from disk, access latency related to the storage devices and network performance. Examples include disk access and Internet router and transmission latency for concurrent streams, tuning to an alternate frequency and starting the conditional access decryption process.

Another problem is that the start time is not absolute. A television program does not always start exactly on time, and even if it does, the start time is relative to the content provider's own clock. Even if all content providers operate from the same master clock, factors like satellite transmission delay, MPEG packet jitter and re-clocking and other effects will result in start time variations for different programs when received by the operator.

An advance pre-roll trigger can be used to within the opportunity to descriptor to advise the receiver that the content substitution must start in an amount of time relative to a reference clock, at an absolute time relative to a reference clock, or in an amount of time relative to a data trigger. The exact method will depend on the capabilities of the receiver.

In one embodiment, the timing mechanisms of the interactive TV system used are sufficient to provide the exact timing. In one embodiment, the discrete tone multi-frequency (DTMF) or a control signal embedded within an MPEG stream in the source stream is used to generate the data required in the opportunity descriptor to describe and accurate start point. DTMF signals are used in broadcast streams to announce the arrival of an advertisement in a fixed time signal, and are commonly used for ad insertion in cable companies, as is known to those of skill in the art.

The injection filters detect the time at which the DTMF signal occurs on a reference clock signal, and the opportunity descriptor characteristic field is generated with a start time relative to the same clock signal or to absolute time with respect to a reference clock. The reference and relative clocks can be MPEG presentation time stamps (PTS) or display time stamps (DTS) within the MPEG stream, or the time-of-day clock stream used in digital television broadcasts, with the DVB SI Time-Date-Table (TDT) as a prominent example.

In another embodiment, the DTMF or its MPEG equivalent is used as a trigger to generate an appropriate sequence for an interactive system like ATVEF or OpenTV. The interactivity commands and/or data sequences are injected into the content stream with appropriate commands and parameters to time the opportunity content switch relative to the insertion of the interactivity stream. This type of insertion would be provided by pre-encoding device or post-encoding device. When switching from one content stream to and from an alternative piece of content, perceptible delays are to be avoided.

In one embodiment, the receiver has a plurality of content processing systems. An alternate content processing system can be used to tune to or pre-queue from storage an alternate content stream, and seamlessly or near-seamlessly switch to the alternate content stream. When seamless or near-seamless transitions are not possible, the alternate content can be modified to accommodate delays in tuning to and returning from the alternate content selection. These modifications can include designing the content so that the start and end portions are less relevant and not significant to the message if missed; a temporal compression of the alternate content so that the start and end are blank or irrelevant for the amount of time it takes, and the message is shortened from its original length through accelerated playback or the removal of selected frames to fit within the shortened display time.

Current implementations of video copy protection schemes involve the modification or addition of components of the video to prevent recording on VCR devices. In analog video transmission, the operator on the transmitted signal performs the modification. In digital video transmission, data transmitted with the video, usually in the form of a true-or-false value, indicates that the receiver, when playing out the video, must perform the video component modification to prevent connected VCRs from recording the content.

The copy protection scheme is extended to receivers with digital storage to encompass the capabilities of the storage by assigning additional meaning to the copy protection flag. When the transmitted video has an indication of copy protection, the flag can include meanings such as the receiver is not permitted to record the content to storage, the receiver is permitted to hold only enough content in storage to allow a pause feature to be implemented. The pause feature may also include a limited amount of rewind time, the receiver is permitted to record the content to storage, but only if encryption facilities are available.

The encryption and subsequent decryption and playback, may require the facilities of the conditional access system, limitations may be placed on the playback, including time limits and number of replays, the receiver must include analog copy protection mechanisms within the video signal to prevent recording on VCRs, and the ability to record and replay and the time limits and number of replays may be subject to permissions assigned by a conditional access system, or as part of rights acquired during the purchase of a pay-per-view event.

As the current copy protection model is based on a binary true-or-false value of the copy protection flag, the copy protection flag can also be extended as a series of flags or as a data structure with multiple fields to allow explicit specification of any or all of the copy protection features listed herein. In the case where storage is located on a network facility, the storage may be shared between receivers. A request to store content is compared to other requests, and if another request has been made to store the same piece of content, the request is ignored. However, a record is made of the multiple requests, and the content is not deleted until either all requestors have issued a delete request or the temporal limits on the recording or the associated permissions have all expired.

During the recording process, the content being recorded may include one or more content targeting opportunities. Depending on the attributes described earlier in this invention for selecting targeted content, including the use of specific attributes or the receiver's capabilities, any or all of the following may be implemented in the content recording process the inclusion in the recording of all of the opportunity and content descriptors, to allow the selection of targeted content to occur during playback as it would during live airing, the recording of the content with the selection of content during opportunities being the same as that which would be made if the content was being watched live, the recording of the content with an alternate selection based on one of the variable within the matching process being an indicator of whether the content is being watched live, recorded, or watched while being recorded.

If the matching process includes a characterization of “watched while being recorded”, then the version of content that is being shown to the watching viewer may be different from the version of content being recorded, provided this capability is available within the receiver. The selection of an alternate version of content specific to an event being recorded can be implemented whether or not the recording feature is integral to the receiver. In one embodiment, the record feature consists of deferred record function available to a user on a receiver, which, when activated, consists of changing to a selected channel near the time of the start of a program, and the control through infrared signals or other protocols of an external recording device. The state of the receiver during the record process can be recognized and used as an argument within the matching algorithm.

Ad independent data is comprised of “Xlet” like executable objects to be run on set-tops and set-top profiling data. Ad independent carousel data could have a different repeat rate than ad dependant data. The rate at which the DE has the ITV spooler repeat the various chunks of data is parameterized. The configuration information may be stored in a properties file, or stored in a LDAP repository. The DE may communicate with one or more ITVS, and the ITVS systems may be heterogeneous. A key capability of the DE is its ability to manage and convert the timing and delivery requirements from the originating sources at the head-end into the appropriate forms required for a variety of combiners.

Storage could be in persistent store if such facilities are available on the box or could be in temporary storage. The MDE also interacts with receiver based conditional access systems (CAS) in order to provide security and privacy for system information. It may be part of the receiver or it may be part of a switched network fabric (xDSL). Since there are a variety of application platforms used by set top vendors, the actual implementation of the MDE may be platform dependent and each platform will have it's own version of a MDE. The MDE collects targeting content, profile information, schedule information and prepares its work environment.

When the MDE recognizes that an opportunity for targeting content will result in the switch from one content stream to another, whether the content is from another stream, storage or another source the MDE must switch as seamlessly as possible from the original to the alternate stream. Access to an alternate stream may not be instantaneous. Preparation required before switching streams includes locating and retrieving content from disk, accounting for latency related to the storage devices and network performance. Examples include disk access and Internet router and transmission latency and tuning to an alternate frequency and starting the conditional access decryption process for concurrent streams.

An advance pre-roll trigger can be used to within the opportunity to descriptor to advise the receiver that the content substitution must start in an amount of time relative to a reference clock, at an absolute time relative to a reference clock, or in an amount of time relative to a data trigger.

The exact method will depend on the capabilities of the receiver. In one embodiment, the timing mechanisms of the interactive TV system used are sufficient to provide the exact timing. In one embodiment, the discrete tone multi-frequency (DTMF) or a control signal embedded within an MPEG stream in the source stream is used to generate the data required in the opportunity descriptor to describe and accurate start point. DTMF signals are used in broadcast streams to announce the arrival of an advertisement in a fixed time signal, and are commonly used for ad insertion in cable companies, as is known to those of skill in the art.

The opportunity descriptor trigger is generated with a start time relative to the same clock signal or to absolute time with respect to a reference clock. The reference and relative clocks can be MPEG presentation time stamps (PTS) or display time stamps (DTS) within the MPEG stream, or the time-of-day clock stream used in digital television broadcasts, with the DVB SI Time-Date-Table (TDT) as a prominent example.

In another embodiment, the DTMF or its MPEG equivalent is used as a trigger to generate an appropriate sequence for an interactive system like ATVEF or OpenTV. The interactivity commands and/or data sequences are injected into the content stream with appropriate commands and parameters to time the opportunity content switch relative to the insertion of the interactivity stream. This type of insertion would be provided by pre-encoding device or post-encoding device.

When switching from one content stream to and from an alternative piece of content, perceptible delays are to be avoided. In one embodiment, the receiver has a plurality of content processing systems. An alternate content processing system can be used to tune to or pre-queue from storage an alternate content stream, and seamlessly or near-seamlessly switch to the alternate content stream.

When seamless or near-seamless transitions are not possible, the alternate content can be modified to accommodate delays in tuning to and returning from the alternate content selection. These modifications can include designing the content so that the start and end portions are less relevant and not significant to the message if missed; a temporal compression of the alternate content so that the start and end are blank or irrelevant for the amount of time it takes, and the message is shortened from its original length through accelerated playback or the removal of selected frames to fit within the shortened display time.

The ME generates a schedule that is published on the software service bus. The schedule describes advertisement opportunities that occur a-priori, the primary/default advertisement, alternate ads and meta-data/profile information for each ad slot. The DE subscribes to this information and uses it to prime ad-insertion and media object servers at the head-end. The DE also creates an opportunity map based on the schedule which describes the ad slots, content, and other meta-information which a MDE would require in order to provide the targeting and presentation function. The opportunity map also describes the mechanisms by which alternate/targeted ad content can be picked up by the MDE. The DE will then broadcast this meta-content to a set of receivers.

In an embodiment of the present invention, the system is deployed in a broadcast environment where the network operator uses satellite transmission to viewing devices and TELCO-based return to the network operator's site. In switched environments such as but not limited to DSL networks and video speed Internet, content will be queued and selected at the appropriate time. Within xDSL and Internet environments, a single stream of content will be multicast to a plurality of receivers. In this case the meta-data being sent by the DE describes the access point s at which the content will be available to the MDE.

For asynchronous content transmission, any of the network mechanisms discussed (broadcast or point-to point) can be used. Content on these networks can be transmitted in real-time, or slower or faster than real-time at fixed or variable speeds at alternate times, using transmission formats different from the normal video transmission. For example, a satellite stream for alternate content being transmitted asynchronously may consist of broadcast TCP/IP file transfers within DVB streams, instead of the MPEG-2 packetization normally expected of video streams.

In the present embodiment all the server side engines are connected by a service bus or event bus, which is essentially a software bus that uses Internet or other suitable network(s) as a physical conduit. Event bus provides a software interconnection, typically in the form of events or topics, between software applications and/or objects executing on vending interfaces, purchasing interfaces, matching engines, and delivery engines.

The DE combiner sends, via the broadcast network, meta-data and triggers to the MDE for the purposes of content delivery, capture, targeting, presentation, and feedback. Meta-information for feedback/reporting is sent via middleware infrastructures, which collect information from the combiners, and broadcast this information to the receivers using standard digital broadcast equipment such as MPEG2 multiplexes, and encoders.

The invention has a unique ability to manage feedback bandwidth depending on the broadcast system. The invention has a unique ability to adapt the reporting capability depending on receiver/feedback environment.

The invention provides the ability to target digital content based on receiver capability and viewer demographic profiles. The invention provides the unique ability to use commercial ITV systems to deliver targeting applications and content to digital receivers. The invention provides the unique ability to manage the content delivery through multiple elements of a broadcast activity such as a broadcaster to cable network to receiver.

The invention provides the unique ability to manage and synchronize content delivery across heterogeneous networks. The invention provides the unique ability to adapt receiver based targeting applications to receiver and network environments. The invention provides the ability to perform software updates in real-time and the ability of different targeting applications to configure themselves during run-time.

Automated Reporting

The following section contains more detailed information on aspects of the invention particularly related to the automation of reporting within the system. The present invention is directed to a method and system for automated reporting in a communications network.

In accordance with the present invention, there is provided a method for automated reporting in a communications network, the method comprising the steps of: collecting user data related to content targeting; and reporting said collected data to provide improved targeting.

In accordance with the present invention, there is provided a method for automated reporting in a communications network, the method comprising the steps of: monitoring the programming stream for opportunities and content descriptors; determining the source for alternate content as described previously; matching the opportunity to the available content and the viewer characteristics; presenting the content to the viewer; and updating the secure audit log with the viewing result.

In one embodiment of the present invention, the system includes a delivery engine, a matching engine, a combiner, and an MDE. The MDE has sub-components including a base MDE, a feedback manager, a targeting manager, a presentation manager and a storage manager. The ME, DE, and combiner are all situated in the network's broadcast head-end. MDE's are located at network points and/or on receivers connected to viewing devices such as televisions and personal computers.

The MDE applies the final decision as to how to provide the best choice in targeting content to the viewer and to report back the action performed. To do this it has the responsibility of understanding regular broadcast schedules, functional opportunities, collecting appropriate targeting content, setting and managing up demographic profiles, create and manage audit logs. The MDE also interacts with receiver based conditional access systems in order to provide authentication, authorization and privacy.

The invention provides for reporting viewing records and habits to a data collection system. The invention is suitably used with Cellular telephony; Cable networks; Consumer kiosks such as ATMs; DSL; and IP based networks.

The reporting component can further provide facilities to determine which viewer in a multi-viewer household was watching content without requiring active input from the user. In an embodiment of the present invention, biometric mechanisms are included in end-user equipment such as the receiver or remote control to improve viewer identification precision. In an embodiment of the present invention, the remote control includes a fingerprint reader. The remote control cannot be used unless the appropriate finger is in the reader portion of the device to identify the user. Methods such as the selection of a viewer profile on the receiver can be used.

In an embodiment of the present invention, viewer inputs to the system are recorded, whether from a remote control, keyboard, front panel switches or other input devices. The analysis of keystroke and content selection, timing and combinations can determine, with high probability, which household viewer is currently using the system. Inputs can be analyzed in the receiver or in servers on the operators network.

Other embodiments of the network include direct to home satellite or microwave television distribution system, XDSL and ATM networks, terrestrial television broadcast, cellular telephone, and other networks, and the same or related networks like standard telephone connections for returning data from the receiver.

When content is presented and viewed, the receiver can record the results of the content view in secure storage and report the results to a reporting facility. Based on the results, content providers can further tailor content and parameters to match content with desired viewer.

Another example of the use of secure facilities for storage of data and execution of methods is the maintaining of confidentiality of viewing records, even when use of those records is required for assessing the appropriate content to show when a content viewing opportunity arises.

The presentation methods in the presentation manager function of the MDE can also handle and manage viewer input to control the triggering of functional opportunities. The logging of results can include all inputs from the user. These inputs can be processed within the receiver or at a network site to as part of the analysis of viewing habits and, based on the frequency, selection of inputs, and the resulting content selections, can be used to identify the viewer with a reasonable probability.

The detail level of the logging of the interactions and selections can be based on user selections and permissions performed at the receiver, or based on agreements between the network operator and the viewer, with the operator transmitting permissions to the receiver to set the logging level based on the agreements. These agreements can include some form of payment, discount or other credit for the user.

The reporting methods can process the data to produce derived data for subsequent targeting opportunities. The processing and storage of the resulting data can be performed in whole or in part within the facilities of a conditional access system (CAS). Following processing and reporting of data, the reporting methods manage the space used by the data, and can delete data based on temporal factors, completion of processing, reporting and other considerations.

In one embodiment of the present invention, inputs to the system are recorded, whether from a remote control, keyboard, front panel switches or other input devices. The combination of keystrokes and content selection, through analysis, can determine with a high probability which viewer in the household is currently using the system. The inputs can be analyzed in the receiver or in servers on the operators network.

In one embodiment, a CAS, normally used for impulse pay-per-view purchase recording, can perform results and reporting. The CAS reports both content targeting data and pay-per-view purchase data within the same telephone call to reduce operator telephone toll costs.

The detail level of the reporting of the interactions and selections can be based on user selections and permissions performed at the receiver, or based on agreements between the network operator and the viewer, with the operator transmitting permissions to the receiver to set the logging level based on the agreements. These agreements can include some form of payment, discount or other credit for the user.

Inputs and viewing records can be stored and transmitted securely, and can use available conditional access features. The reporting process is governed by the capabilities of the receiver, and can be performed in real-time or on a deferred basis. Deferred methods are particularly important when a reporting network is a telephone network and an operator is paying toll charges for the telephone call. An aggregation and occasional reporting of stored data can result in substantial cost savings.

Once the MDE targets and presents content, it logs information such as what content was played, time it was played and demographic match processed to arrive at the presentation decision. The MDE activates the reporting component based on reporting triggers it receives from internal settings such as time of day alarms, and/or specific interaction at the receiver or external real-time triggers from the matching engine and delivery engine. When activated, the reporting component will transmit the logged information as required by the head-end trigger. This trigger also contains the address and phone number to be connected to for sending the reporting information.

As well, triggers can be demographic based and/or statistically based to manage the volume of data reported. As an example, a trigger can be created for all receivers in a particular postal code area to signal their reporting agent to activate. This can be especially beneficial to satellite MSO's whose broadcasts are transmitted over a wide geographical area, but who only want feedback from specific locations. Segregating the call back in this fashion also allows TELCO-based return systems to load balance their reporting mechanisms so that different postal codes are assigned different phone number end-points for reporting. The server components at the end of these phone number end-points can then aggregate the localized reporting and use more robust networks, such as broadband IP networks, to send the data to a bank of central servers at a control center.

In an embodiment of the present invention, reporting is performed by a conditional access system (CAS) normally used for impulse pay-per-view purchase recording. The conditional access system can report both content targeting data and pay-per-view purchase data within the same telephone call to reduce operator telephone toll costs. In an embodiment of the present invention, the system is deployed in a broadcast environment where the network operator uses satellite transmission to viewing devices and TELCO-based return to the network operator's site, typically referred to as the head-end. Other secure subsystems can be used and are known to those of skill in the art.

The MDE is either embedded within the receiver software or is streamed out by the delivery engine through the combiner and loaded onto the receiver from the broadcast stream. The MDE can examine the receiver environment and available functionality and uses this information to load its constituent components. In one embodiment being described the base MDE determines that the return path to the head-end is via a TELCO phone line and loads the appropriate reporting component that understands the specifics of dealing with phone lines.

The delivery engine and spooler send, via the broadcast network, meta-data and triggers to the MDE for the purposes of content delivery, capture, targeting, presentation, and feedback. Meta-information for reporting is sent via middleware infrastructures which collect information from the combiner and broadcast this information to the receivers using standard digital broadcast equipment such as MPEG2 multiplexes and encoders.

The matching engine and delivery engine also send down configuration triggers that indicate to the MDE if certain components need to be replaced. This allows for dynamic adaptation of the system to new feedback algorithms, better functional capability, and bug fixes to component code.

At anytime an MDE can replace itself in while or in part with another MDE available on the carousel or the MDE may remain resident on the receiver. This gives the system the ability to modify its reporting mechanism dynamically. This flexibility can be carried back up the supply chain to allow the originators of targeted content to customize methods used to target that content on a per instance basis.

Different viewer configurations can have different reporting components based on the receiver's capability and environment. The MDE can in real-time update its reporting sub-system to reflect the receiver hardware configuration For example, for receiver's with a modem connection, a reporting component that knows how to deal with modems can be downloaded. Similarly, IP-enabled receivers can use an IP-aware reporting system.

The MDE present on the receiver will report targeting and presentation information based on triggers sent to it via a data carousel and/or other data transfer mechanisms. The MDE contains the reporting component, offering a solution with several advantages for Network Operators over existing systems. The trigger can be based on geographical or other targeting meta-data. Triggered reporting will be used to activate groups of MDE's in cases where feedback bandwidth is expensive. Triggers will also indicate what type and amount of report data is required.

Another advantage of the MDE architecture is that an MDE can reside inside or outside of security infrastructure provided on a receiver. Access to confidential information and receiver resources, such as disk access, can be restricted based on the request being generated by an MDE. For instance, requests for a subscriber's personal information and receiver recourses necessary to target content can be controlled based on the content targeting request, which channel, which advertiser. By taking into account the agency requesting the information and resources, and the nature of those requests, the MDE can work with existing conditional access system (CAS) or other security infrastructures to determine if the MDE may use those desired resources on behalf of the requesting agency.

The invention uses commercial infrastructure for the deployment and delivery of targeting applications and content. This means that Network operators who already operate with such infrastructure will be able to deploy the reporting system on existing environments with little or no new expenditure.

The system comprises control, management and distribution elements spanning from the placement at scheduling of content from the broadcaster and its proxies such as advertising-related agencies, through to multiple cable or satellite distribution networks, to the receiver at the customer premises, and in feeding back data from the viewing at the receiver to the appropriate systems. It also allows for reporting from a receiver-based MDE based on triggers/signals from a server at a broadcast head-end.

The invention has the ability to provide reporting feedback on targeted content selection and presentation, and has the ability to manage reporting bandwidth depending on the broadcast system. The invention has the ability to adapt the reporting capability depending on receiver/reporting environment. The invention has the ability to provide selective reporting on demand in a multicast broadcasting or point-to-point environment. The invention enables the ability to provide reporting through relatively low-bandwidth networks for existing satellite and microwave broadcasting systems, securely and at a reasonable cost, as well as over IP-based high-bandwidth networks.

Although the present invention has been described in considerable detail with reference to certain preferred embodiments thereof, other versions are possible. Therefore, the spirit and scope of the appended claims should not be limited to the description of the preferred embodiments contained herein.

What is claimed is:

1. A method for informing a receiver connected to one or more networks of a content targeting opportunity and for the receiver to exercise the opportunity by selecting and displaying content from a selection of content comprising any or all of the steps of:
Securely receiving and securely storing characteristic information about the viewer
Securely receiving and securely storing characteristic information about a selection of content
Securely receiving and securely storing characteristic information about viewing opportunities
Securely receiving and decrypting the viewer, content and opportunity characteristics
Determining which versions of content are physically accessible to the receiver based on the characteristics of the content and the opportunity
Determining which versions of the content the receiver is permitted to access
Running an opportunity matching process to determine which accessible and permitted versions of the content best match the viewer, opportunity and content characteristics and records of prior content viewing
Accessing and displaying the content when the opportunity is exercised
Securely storing the results of the convent viewing
Securely reporting the information on the content viewing to a reporting facility.

2. A method as defined in claim 1, for a receiver connected to one or more networks to select and acquire content from a selection of content for subsequent targeted content viewing opportunities comprising any or all of the steps of:
Securely receiving and securely storing characteristic information about the viewer
Securely receiving and securely storing characteristic information about a selection of content
Securely receiving and securely storing characteristic information about viewing opportunities
Securely receiving and decrypting the viewer, content and opportunity characteristics
Determining which versions of content are physically accessible to the receiver based on the characteristics of the content and the opportunity
Determining which versions of the content the receiver is permitted to access
Running a content matching process to determine which accessible and permitted versions of the content best match the viewer, opportunity and content characteristics and records of prior content viewing
Determining if permission is available to use storage accessible to the receiver with characteristics suitable for real-time playback with predictable content access latency characteristics (“local storage”)
Determining if sufficient space is available on local storage, and deleting any less-suitable content to make space available Acquiring and storing the content on the local storage OPPORTUNITY TYPES

3. The method of claim 1, where the opportunity is based on the invocation of a function or group of functions on the receiver device

4. The method of claim 1, where the type of content selected can be based on the characteristics of the opportunity

5. The method of claim 1, where the characteristics of the opportunity and/or content can cause the process to select the content for display based on the timing and/or content selection for prior opportunities

6. The method of claim 1, where the characteristics of the opportunity and/or content can cause the process not to select any content for display based on the timing and/or content selection for prior opportunities CONDITIONAL ACCESS

7. The method of claims 1, where the opportunity matching process and/or the content matching process can be executed in whole or in part within one or more components of a receiver and/or to one or more devices on a network

8. The method of claim 1, where the viewer characteristics can be located in whole or in part within one or more components of a receiver and/or to one or more devices on a network

9. The methods of claim 1, where any or all of the permission to access storage, the storage of some or all of the characteristics, the execution of all or a portion of the opportunity matching process and/or the content matching process, the storage of the content viewing results, and the communication or the viewing results can be performed and managed on one or more of the following facilities:
a smart card
a security module which can include software and interfaces to the receiver and a smart card
the facilities of an analog or digital television conditional access system, which may include any of a smart card, a security module and other hardware within the system
the facilities for electronic commerce system, which may include a smart card, a security module and other hardware within the system
a smart card which has an operating system that allows multiple independent applications
one or more grant/deny type servers accessible on a network
one or more Kerberos of other ticket server systems accessible on a network
an interactive application system including those in claim 23

10. The methods of claim 1, where, in whole or in part the characteristics of the content, applications and/or viewers can be encrypted prior to transmission and decrypted and accessed using any of the facilities of claim 9.

11. The methods of claim 1 where the encryption and decryption can use any of the facilities of claim 9.

12. The method of claim 1, where the content, opportunity and viewer descriptors can include a variable and extensible number of characteristics

13. The method of claim 1, where all or a portion of the algorithm for the processes for matching the content, viewer and/or opportunity characteristics can be transmitted as one of the opportunity or content characteristics

14. The method of claim 1, where the viewer characteristics can beindependently available on the receiver, including any of the facilities of claim 9, including but not limited to:
Postal code
Telephone number
Access permissions, including digital television service and channel authorizations
Prior purchases, including television pay-per-view movies
Viewer channel selection and EPG display profiles
Viewer content filtering criteria, including VCHIP settings and ratings

15. The methods of claim 1, where the execution of the content matching process and/or the opportunity matching process can be performed within any of the facilities of claim 9, so that only some or none of the characteristics are retrieved from the facilities of claim 9, and only the result of the matching processes is returned without returning any of the characteristics

16. The methods of claims 1 and 2, where the characteristic information for an instance of content can include one or more of the following:
A maximum number of repetitions
A minimum amount of time between showings
A maximum number of incomplete repetitions
A time window for usage
Technical requirements for usage of the content on the receiver
The source or sources for the content
A sequence number for content consisting of multiple instances of content within a sequence

17. The methods of claim 1, where the exercising opportunity can be based on the invocation of a function on the receiver, including:
Turning on the receiver
Turning off the receiver
Starting the playback of stored content
Pausing the playback of stored content
Starting a communication session
Stopping a communication session
Pausing the viewing of broadcast content through the use of time-delay storage features
Resuming the viewing of broadcast content following the use of time-delay storage features

18. The methods of claim 1, where the opportunity can be based on any one of a plurality of advertising slots available on a plurality of channels which are related for the purposes of sharing the advertising on each channel for managing and targeting the advertising opportunities

19. The methods of claim 1 where the opportunity can be based on any one of a plurality of advertising slots available on a single channel.

20. The methods of claim 1, where the opportunity and selection of content can be based on a combination of the exercising of opportunities based on a combination of any or all of the methods of claims 16, 17, 18 and 19 and the frequency of, time of, and time separating the exercising of said opportunities

21. The methods of claim 1, where the receiver can be connected to one or more networks which can consist of any one or more of the following, but not limited to:
a direct-to-home satellite broadcasting system (DTH)
a cable television network
a terrestrial radio frequency network, including LMDS and MMDS
a packet switched terrestrial network, including ATM and DSL networks
packet switched or routed networks consisting of multiple channels on multiple streams of the transport layer, including but not limited to ATM virtual circuits in all their embodiments, and IP unicast or multicast streams
a terrestrial cellular communication network, including telephone networks
the public telephone network
the Internet, through cable, xDSL, telephone, wireless or other broadband connection methods, including MMDS and LMDS
a terrestrial television broadcast network, including NTSC, ATSC, DVB and other protocols

22. The methods of claim 1, where the transmission protocol for the characteristics can consist of one or more of the following operating over the networks of method 21, including but not limited to:
MPEG transport streams
DVB transport streams
Vertical blanking interval or other portions of television signals allowing the carriage of data, including ATVEF transport A and transport B streams
TCP/IP transport streams, either directly within the networks of method 21, as defined within another specification like DVB or any of the IETF specifications
Private data fields within a DVB Event Information Table (EIT)

23. The methods of claim 1, where the algorithms, processes and characteristics can be represented as part of or extensions to the specifications of one or more interactive applications and communication specifications, including but not limited to:
JavaTV
OpenTV
ATVEF
DVB MHP
WAP
NTT DoCoMo
Wink

24. The methods of claim 1, where the receiver is a digital set-top cable or satellite television receiver; a set of components within a television; a personal computers with appropriate network connections, a cellular telephone or a personal digital assistants (PDA); or a gaming console.

25. The methods of claim 1, where the receiver can have the ability to handle multiple content streams simultaneously, allowing the acquisition of characteristics and content simultaneously with the viewing of content

26. The methods of claim 1, where the receiver can acquire content using viewing facilities when the receiver is not being used for viewing

27. The methods of claim 1, where the content alternatives can consist of content on a variety of services which are unrelated except for the synchronization of the start and end times of the content alternatives

28. The methods of claim 1, where the content alternatives can consist of streams of alternative content which can be used by a plurality of services as a source of content alternatives, and the scheduling of the alternate content and the services allows the alternatives to be shared among the plurality of services

29. The methods of claim 28 where the bandwidth can be available from services which are not airing through simultaneous substitution requirements

30. The methods of claim 28 where the bandwidth can be available from services which are temporarily off air, whether on a regular or occasional basis.

31. The methods of claim 1, where the alternative versions of content can be available from a switched network like DSL

32. The methods of claim 1, where the content alternatives can be transmitted in non-real-time, being either faster or slower than real-time, using methods other than the primary content transfer mechanism

33. The methods of claim 1, where the start point for the switch to an alternative content stream can be based on timing relative to a reference clock, where the relative clocks consists of any one of:
A time-of-day reference time stream available to the receiver, of which the DVB time date table (TDT) is an example
An MPEG presentation time stamp (PTS)
An MPEG display time stamp (DTS

34. The methods of claim 1, where the start point for the switch to an alternative content stream can be based on an amount of time from a detectable event in the video stream, such as the DTMF signal other trigger mechanisms or data elements that can be used as trigger mechanisms within analog or digital streams

35. The methods of claim 1, where the matching can be based on geographical locations and the locations and the receiver's knowledge of its location are based on the technology used to implements black-outs within the receiver, through a matching of content to each area within the black-out pattern.

36. The methods of claim 1, where the user's inputs can be recorded and reported to calculate the probability of which viewer within a household was watching the program at any given time

37. The methods of claim 1, where the level of detail of detail to be reported can be based on the permission the user has agreed to, and the level can be controlled within the receiver functions

38. The methods of claim 37 where the viewer's permission is obtained by one or more of the following:
An agreement at the time of acquisition of the receiver by the viewer, which may be obtained through a subsidized purchase or rental price
A reduction in the price of the service, or a credit towards specific services
A direct payment to the viewer

39. The methods of claim 1, where the viewing of the selected content alternative can be deemed to be uninterruptible, regardless of the action taken by the user on the inputs to the receiver

40. The methods of claim 1, where the indications that the content is being recorded or is to be recorded at a later time can be used as a criteria for matching the content to the opportunity

41. A method for providing copy protection on the content being transmitted by using existing copy protection indicators and/or extensions to those indications to indicate one or more of the following restrictions are in place for the content:
The receiver is not permitted to record the content to storage
The receiver is permitted to hold only enough content in storage to allow a pause feature to be implemented. The pause feature may also include a limited amount of rewind time
The receiver is permitted to record the content to storage, but only if encryption facilities are available. The encryption and subsequent decryption and playback, may require the facilities of the conditional access system.
Limitations may be placed on the playback, including time limits and number of replays
The receiver must include analog copy protection mechanisms within the video signal to prevent recording on VCRs
The ability to record and replay and the time limits and number of replays may be subject to permissions assigned by a conditional access system, or as part of rights acquired during the purchase of a pay-per-view event.

42. The methods of claims 2, where the storage is a pool of storage available on any of the connected networks, and the content is managed in a manner that any specified piece of content is only stored once on the network, even though multiple users or the content selection methods for those users have requested storage of the content

43. The method of claim 2, where the characteristics of content that is already stored can be updated by transmitting changes to the characteristics

44. The method of claims 1, where multiple versions of interactive applications can be sent on and cached from one stream, and triggered after the service has been switched to an alternative content stream.

45. The methods of claim 1, where the receiver can have the ability to handle multiple content streams simultaneously, and the facilities for handling a separate stream is used for tuning to or queing from storage the alternate content display to allow a seamless or near-seamless transition to and from the alternate stream.

46. The methods of claim 1, where the content can be modified to accommodate delays in tuning to and returning from the alternate content selection. These modifications can include designing the content so that the start and end portions are less relevant and not significant to the message if missed; a temporal compression of the alternate content so that the start and end are blank or irrelevant for the amount of time it takes, and the message is shortened from its original length through accelerated playback or the removal of selected frames to fit within the shortened display time.

47. The methods of claim 1, where the selection of the content alternatives, the selection and attribution of characteristics to opportunities and content, the transmission mechanisms selected for the content and opportunities, and the methods used for matching the content and opportunities can be based on yield management methods, an example of which is optimal dynamic pricing.

48. A method for informing a receiver connected to one or more networks of a content targeting opportunity and for the receiver to exercise the opportunity by selecting and displaying content from a selection of content, the method comprising the steps of:
receiving and storing characteristic information about the viewer;
receiving and storing characteristic information about a selection of content;
receiving and storing characteristic information about viewing opportunities;
determining which versions of content are physically accessible to the receiver;
determining which versions of the content the receiver is permitted to access;
running an opportunity matching process to determine which accessible and permitted versions of the content match the viewer, opportunity and content characteristics;
accessing and displaying the content when the opportunity is exercised;
storing the results of the convent viewing;
reporting the information on the content viewing to a reporting facility.

49. A method of selecting and acquiring content from a selection of content for subsequent targeted content viewing opportunities by a receiver connected to one or more networks, the method comprising the steps of:
receiving and storing characteristic information about the viewer;
receiving and storing characteristic information about a selection of content;
receiving and storing characteristic information about viewing opportunities;
determining which versions of content are physically accessible to the receiver;
determining which versions of the content the receiver is permitted to access;
running a content matching process to determine which accessible and permitted versions of the content best match the viewer, opportunity and content characteristics;
determining if permission is available to use storage accessible to the receiver with characteristics suitable for real-time playback with predictable content access latency characteristics (“local storage”);
determining if sufficient space is available on local storage;
deleting content to make space available;
acquiring and storing the content on the local storage.

50. A method for the targeting of content presentation to individual users in a communications network including management and reporting, comprising the steps of:
Receiving from content providers, potential content for presentation to users; and
Presenting to a user content selected from said potential content based on information known about said user.

51. A method for the targeting of content presentation to individual users in a communications network including management and reporting, comprising the steps of:
Receiving from content providers, potential content for presentation to users;
Receiving from a user requests for content and other actions related to receipt of said content such as ‘pause’ requests;
Selecting, using information known about said user, said requests and said actions received from said user, which of said potential content to present to said user;
Presenting to said user said selected content; and
Recording and reporting the fact that said content has been presented to said user.

52. A system for the targeting of content presentation to individual users in a communications network including management and reporting, comprising the steps of:
Means for receiving from content providers, potential content for presentation to users; and
Means for presenting to a user content selected from said potential content based on information known about said user.

53. A system for the targeting of content presentation to individual users in a communications network including management and reporting, comprising:
Means for receiving from content providers, potential content for presentation to users;
Means for receiving from a user requests for content and other actions related to receipt of said content such as ‘pause’ requests;
Means for selecting, using information known about said user, said requests and said actions received from said user, which of said potential content to present to said user;
Means for presenting to said user said selected content; and
Means for recording and reporting the fact that said content has been presented to said use
